(19) United States
(12) Patent Application Publication
(10) Pub. No.: US 2023/0068000 A1
(43) Pub. Date: Mar. 2, 2023

(54) COLORIMETRIC SENSOR FOR DETECTION OF A CONTAMINANT IN THE INDOOR ENVIRONMENT AND RELATED SYSTEMS

(71) Applicant: Ohio State Innovation Foundation, Columbus, OH (US)

(72) Inventors: Karen DANNEMILLER, Columbus, OH (US); Rongjun QIN, Powell, OH (US); Jonathan PARQUETTE, Hilliard, OH (US); Pelagia-Irene GOUMA, Columbus, OH (US)

(21) Appl. No.: 17/792,602

(22) PCT Filed: Jan. 13, 2021
(86) PCT No.: PCT/US2021/013218

§ 371 Date: Jul. 13, 2022

Related U.S. Application Data
(60) Provisional application No. 62/960,409, filed on Jan. 13, 2020.

(51) Int. Cl. G01N 21/78; G01N 31/22

(52) U.S. Cl. CPC G01N 21/783; G01N 31/22

(57) ABSTRACT

Colorimetric sensors for the detection of contaminants are described herein. In some implementations, the contaminant is formaldehyde. In other implementations, the contaminant is an allergen. Systems and methods for measuring contaminant concentration are also described herein. The colorimetric sensors described herein can be included in or used by disclosed systems and methods. Additionally, the systems and methods described herein can measure the concentration of the contaminant in an indoor environment using the colorimetric sensors.

### CROSS-REFERENCE TO RELATED APPLICATIONS

This application claims the benefit of U.S. provisional patent application No. 62/960,409, filed on Jan. 13, 2020, and titled “Colorimetric sensor for detection of a contaminant in the air in the indoor environment and a smartphone app to measure the contaminant concentration,” the disclosure of which is expressly incorporated herein by reference in its entirety.

### STATEMENT REGARDING FEDERALLY FUNDED RESEARCH

This invention was made with government support under Grant nos. CBET1645048 and CMMI1833345 awarded by the National Science Foundation and OHHHU0057-20 awarded by the U.S. Department of Housing and Urban Development. The government has certain rights in the invention.

### BACKGROUND

In the developed world, we spend 90% of our time indoors where we are exposed to a variety of chemicals. These indoor pollutants are often present at concentrations that are higher than outdoors levels. Some compounds like formaldehyde are ubiquitous in the indoor environment and found in nearly all homes. Sources of formaldehyde indoors are varied and include pressed wood products like plywood and particleboard, some adhesives, personal care products, paints, and other sources.

Formaldehyde exposure is associated with known health effects. These include eye, nose, and respiratory tract irritation. Formaldehyde is also a human carcinogen. Some people are more sensitive than others to developing health effects. While formaldehyde is present in nearly all indoor environments, in some homes it is present at elevated levels. Many other chemical compounds are also present in the indoor environment that have known health effects. These include NOx, ozone, benzene, and many others.

Asthma affects 8% of the U.S. population and has an annual cost of $81.9 billion. This disease disproportionately affects minority communities, especially those in low-income, urban areas, and this disparity has been partially associated with poor housing conditions. Asthma is poorly controlled for many children. Poor control may result from in-home exposures to asthma triggers, including inhalant allergens from cockroach, dust mite, mouse, and mold. These allergens are often present in the dust found in a home. Once triggers are identified, cost-effective measures like integrated pest management (IPM) are readily available to reduce exposure and asthma morbidity. The removal or reduction of household asthma triggers is an effective intervention strategy to reduce asthma symptoms for children with allergic sensitization and domestic exposure to those same allergens without the use of medication (thus reducing associated unwanted side effects). Trigger removal from homes of asthmatic children can result in fewer symptom-days per year, additional days in school, and fewer acute care visits. However, effectiveness is currently limited by the ability of visiting caregivers to accurately assess the presence of high-priority triggers to optimize distribution of limited resources.

Currently, it is difficult for most people to measure these compounds in the indoor environment. This is true even though color-changing sensors exist in the literature. Many analytical methods require expensive equipment that must be used and maintained by a trained operator. Some methods are prone to contamination, and some tests are difficult to conduct. Additionally, it can be difficult for many people to interpret the results.

### SUMMARY

Colorimetric sensors for the detection of contaminants are described herein. In some implementations, the contaminant is formaldehyde. In other implementations, the contaminant is an allergen. Systems and methods for measuring contaminant concentration are also described herein. The colorimetric sensors described herein can be included in or used by disclosed systems and methods. Additionally, the systems and methods described herein can be used to measure the concentration of the contaminant in an indoor environment.

In a first aspect, a sensor for the detection of formaldehyde is provided comprising a substrate; and a reporter compound having the structure:

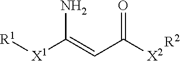

wherein all variables are as defined herein.

In some embodiments of the first aspect, the reporter compound is impregnated, coated, and/or conjugated to the substrate. In some embodiments of the first aspect, the substrate comprises a cellulosic material. In some embodiments of the first aspect, the sensor comprises a reporter compound conjugated to a cellulosic material. In some embodiments of the first aspect, the substrate is in contact with a base, e.g., a transparent base or an opaque base.

In some embodiments of the first aspect, the sensor is prepared by a process comprising the steps: (i) forming a solution or dispersion of the reporting compound in a suitable solvent; (ii) contacting the substrate with the solution or dispersion; and (iii) evaporating the solvent. In some embodiments of the first aspect, the sensor is prepared by a process comprising submerging the substrate in a solution or dispersion of the reporter compound, or spraying, painting, or coating a solution or dispersion of the reporter compound on at least one surface of the substrate.

In a second aspect, a sensor for detecting an allergen is provided comprising a composition material including a nanofibrous substrate and an antibody with specificity for the allergen encapsulated within the nanofibrous substrate.

In some embodiments of the second aspect, the allergen comprises an airborne allergen or an environmental allergen (e.g., Bla g 1, Bla g 2, Can f 1, Can f 3, Der f 1, Der f 2, Der p 1, Der p 2, Fel d 1, Fel d 2, Mus m 1, and Rat n 1). In some embodiments of the second aspect, the nanofibrous material is prepared by electrospinning a mixture of a polymer and the antibody. In some embodiments of the second aspect, the nanofibrous material comprises polyvinylpyrrolidone (PVP), polyvinyl alcohol (PVA), polyethylene glycol (PEG), and/or polypropylene glycol (PEG). In some embodiments of the second aspect, the antibody is conjugated to a labeling agent (e.g., a dye or a porphyrin).

In a third aspect, an example computer-implemented method for estimating chemical or allergen concentration in an environment is provided. The method includes receiving a first image of a color-changing badge and receiving a second image of the color-changing badge. The color-changing badge includes a reaction area and a calibration area, and the color-changing badge includes at least one coded-marker. The method also includes identifying the at least one coded-marker within the first image or the second image of the color-changing badge, and estimating, using the at least one coded-marker, an orientation of the color-changing badge. The method further includes extracting respective color values within the reaction area and the calibration area of the color-changing badge in the second image, calculating a color change ratio between the reaction area and the calibration area of the color-changing badge in the second image based on the respective extracted color values and correlating the color change ratio to a concentration of a chemical or an allergen.

Additionally, the method optionally further includes validating respective colorimetric ranges for the reaction area and the calibration area of the color-changing badge.

Alternatively or additionally, the method optionally further includes providing a notification to a user, where the notification includes instructions for capturing at least one of the first image or the second image of the color-changing badge. For example, the instructions for capturing at least one of the first image or the second image of the color-changing badge can include at least one of an optimal angle or distance for image capture.

Alternatively or additionally, the method optionally further includes providing a concentration notification to a user, where the concentration notification includes the concentration of the chemical or the allergen. For example, the concentration notification can include a health risk associated with the concentration of the chemical or the allergen and/or instructions for reducing the concentration of the chemical or the allergen.

Alternatively or additionally, the method optionally further includes providing a warning notification to a user, where the warning notification includes information about a condition that impacts accuracy of the correlation. For example, the condition that impacts accuracy of the correlation can be lighting, image quality, contamination, camera view direction or a combination thereof.

Alternatively or additionally, the method optionally further includes initiating a timer in response to receiving the first image of the color-changing badge, using the timer to measure a predetermined exposure period, and providing an exposure notification to a user after expiration of the predetermined exposure period, where the exposure notification includes permission to capture the second image. In some implementations, the predetermined exposure period is at least 12 hours. Optionally, the predetermined exposure period is about 72 hours.

Alternatively or additionally, the calibration area of the color-changing badge is a multi-color calibration area. For example, the multi-color calibration area can include a plurality of regions, each region having a different color or a different tint or shade of the same color.

Optionally, the first image or the second image is captured by a portable computing device.

Alternatively or additionally, the chemical is formaldehyde.

Alternatively or additionally, the allergen is from at least one of cockroach, dust mite, mouse, cat, dog, rat, or mold.

Alternatively or additionally, the environment is an indoor environment.

Alternatively or additionally, the color-changing badge is the sensor as described herein.

In a fourth aspect, another example computer-implemented method for estimating chemical or allergen concentration in an environment is provided. The method includes receiving an image of a color-changing badge. The color-changing badge includes a reaction area and a calibration area, and the color-changing badge includes at least one coded-marker. The method also includes identifying the at least one coded-marker within the image of the color-changing badge, and estimating, using the at least one coded-marker, an orientation of the color-changing badge. The method further includes extracting respective color values within the reaction area and the calibration area of the color-changing badge in the second image, calculating a color change ratio between the reaction area and the calibration area of the color-changing badge in the second image based on the respective extracted color values and correlating the color change ratio to a concentration of a chemical or an allergen.

Additionally, the method optionally further includes validating respective colorimetric ranges for the reaction area and the calibration area of the color-changing badge.

Alternatively or additionally, the method optionally further includes providing a notification to a user, where the notification includes instructions for capturing the image of the color-changing badge. For example, the instructions for capturing the image of the color-changing badge can include at least one of an optimal angle or distance for image capture.

Alternatively or additionally, the method optionally further includes providing a concentration notification to a user, where the concentration notification includes the concentration of the chemical or the allergen. For example, the concentration notification can include a health risk associated with the concentration of the chemical or the allergen and/or instructions for reducing the concentration of the chemical or the allergen.

Alternatively or additionally, the method optionally further includes providing a warning notification to a user, where the warning notification includes information about a condition that impacts accuracy of the correlation. For example, the condition that impacts accuracy of the correlation can be lighting, image quality, contamination, camera view direction or a combination thereof.

Alternatively or additionally, the calibration area of the color-changing badge is a multi-color calibration area. For example, the multi-color calibration area can include a plurality of regions, each region having a different color or a different tint or shade of the same color.

Optionally, the image is captured by a portable computing device.

Alternatively or additionally, the chemical is formaldehyde.

Alternatively or additionally, the allergen is from at least one of cockroach, dust mite, mouse, cat, dog, rat, or mold.

Alternatively or additionally, the environment is an indoor environment.

Alternatively or additionally, the color-changing badge is the sensor as described herein.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example color-changing badge according to an implementation described herein.

FIG. 2 is a flowchart illustrating example operations performed by an example software application according to an implementation described herein.

FIG. 3 is a graph illustrating smartphone-based results from a color-changing formaldehyde detection badge (illumination vs. concentration) according to an implementation described herein.

FIGS. 4A and 4B illustrate the reaction area of two color-changing badges that are visually indistinguishable.

FIG. 5 illustrates another example color-changing badge according to an implementation described herein.

FIG. 6 is an example computing device.

FIGS. 7A and 7B are flowcharts illustrating example operations for estimating chemical or allergen concentration in an environment according to implementations described herein.

FIG. 8A is an image of as-spun nanofibrous mats according to an example described herein. FIG. 8B is an image of the typical morphology of the fibrous electrospun mats under microscopy according to an example described herein. FIG. 8C is an image of confocal microscopy results that confirm the encapsulation of antibodies according to an example described herein. FIG. 8D is an image of transmission electron microscopy (TEM) results that confirm the encapsulation of antibodies according to an example described herein.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

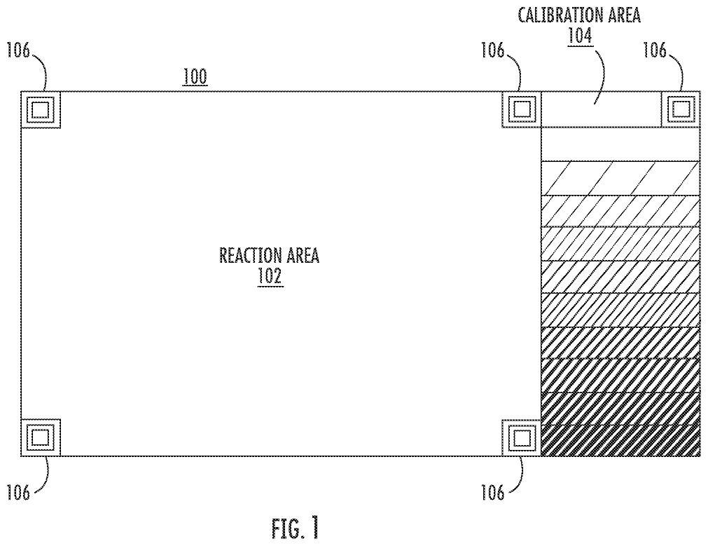

Referring now to FIG. 1, an example color-changing badge 100 is shown. The badge 100 includes a reaction area 102 and a calibration area 104. The badge 100 also includes at least one coded-marker 106. The coded-marker 106 can optionally be a QR code. Although QR codes are provided as example coded-markers herein, this disclosure contemplates that the coded-markers can be another type of fiducial marker including, but not limited to, one-, two-, and three-dimensional codes. For example, the badge 100 includes a plurality of coded-markers 106, one in each corner of the reaction area 102 and one in the calibration area 104 of the badge 100. As described further below, the code-marker(s) can be used to estimate orientation of the badge 100. It should be understood that the number, type, arrangement, and/or locations of the coded-markers in the badge 100 below are provided only as an example. Additionally, the badge 100 includes a multi-color calibration area as described further below.

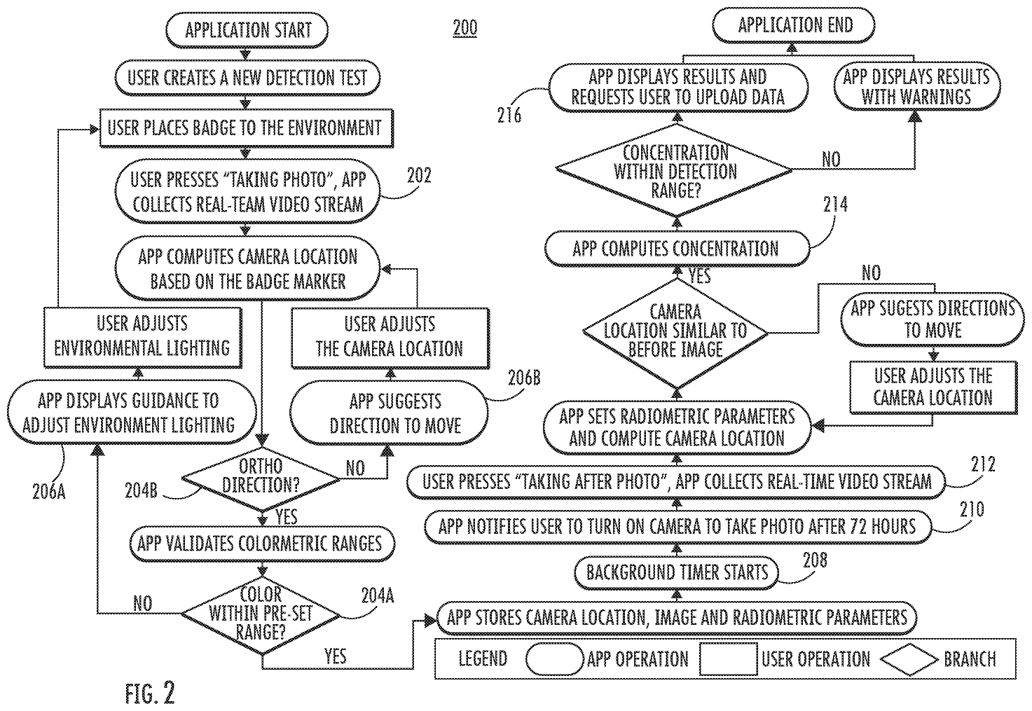

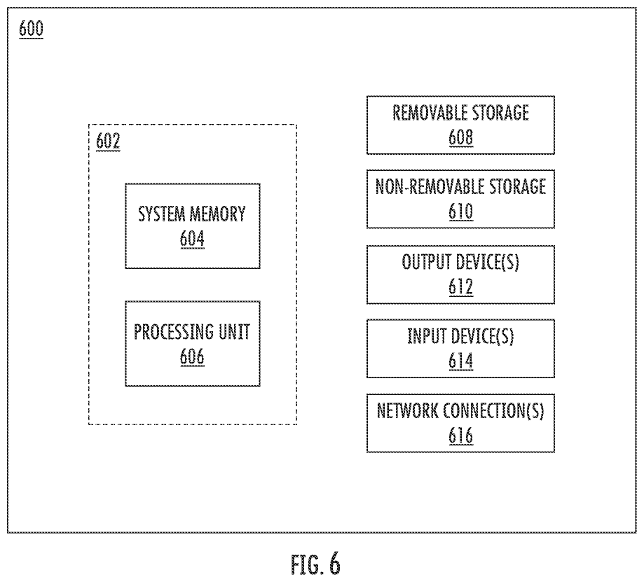

The systems and methods described herein combine a color-changing badge (see e.g., color-changing badge 100 shown in FIG. 1) with a software application (see e.g., flowchart 200 shown in FIG. 2) to measure chemical concentration in the indoor environment. This disclosure contemplates that the software application can be designed to run on a mobile computing device such as a smartphone (also referred to herein as “mobile app” or “smartphone app”). Although smartphone app examples are provided below, this disclosure contemplates that the software application can be designed to run on other types of computing devices (e.g., computing device 600 shown in FIG. 6), which include but are not limited to tablets. The badge 100 is opened and exposed to the air in a room for a certain period of time. In other implementations, a sample (e.g., an aqueous solution containing dust) is applied to the badge 100, and the sample reacts with the badge 100. The user takes a “before” image of the reaction area 102 (e.g., the color-changing area) and calibration area 104, and the app provides a warning if the badge 100 is contaminated at this time. After the time period is complete, the user receives a notification within the app to take the “after” picture. The app then calculates the color change by comparing the color of the reaction area 102 to the colors in the calibration area 104. The app also checks for other problems such as low lighting and can report these issues to the user. If there are no warnings, the app reports the contamination concentration to the user. The user can then also access educational materials about what this levels means and/or how to reduce the level if they desire.

One compound that can be detected using the disclosed systems and processes is formaldehyde. Colorimetric chemical sensors for the detection of formaldehyde, a common indoor pollutant generally function by reacting with formaldehyde to initially form an imine that further transforms into a colored chromophore. Although there are many sensors available based on this concept, to the present disclosure uses in some aspects a simple, cost-effective sensor Fluoral-P to impregnate a nanofibrous substrate (see Wang, X., et al., Colorimetric sensor strips for formaldehyde assay utilizing fluoral-p decorated polyacrylonitrile nanofibrous membranes. Analyst, 2013.138(17): p. 5129-36), such as paper or a nanoporous, monolithic matrices based on silica (see Zong, J., et al., Rapid and highly selective detection of formaldehyde in food using quartz crystal microbalance sensors based on biomimetic poly-dopamine functionalized hollow mesoporous silica spheres. Sensors and Actuators B: Chemical, 2018. 271: p. 311-320) to create a detector. (See Mariano, S., et al., Colorimetric detection of formaldehyde: A sensor for air quality measurements and a pollution-warning kit for homes. Procedia Engineering, 2010. 5: p. 1184-1187). Fluoral-P is known to react selectively with formaldehyde to give 3,5-diacetyl-1,4-dihydrolutidine, which absorbs in the region of 400-450 nm, producing a yellowish-green color that is visible to the human eye. The color of the detector can be further optimized by replacing the methyl groups of Fluoral-P with aromatic chromophores, such as naphthalene, to red-shift the absorption of the sensor. (See Mohr, G J., New chromogenic and fluorogenic reagents and sensors for neutral and ionic analytes based on covalent bond formation—a review of recent developments. Anal Bioanal Chem, 2006. 386(5): p. 1201-14). When formulated as colorimetric test strips, Fluoral-p has been shown to only be responsive to formaldehyde in the presence of contaminants such as acetaldehyde, acetone, ethanol, ammonia, and dimethylformamide, among others. (See Wang, X., et al., Calorimetric sensor strips for formaldehyde assay utilizing fluoral-p decorated polyacrylonitrile nanofibrous membranes. Analyst, 2013. 138(17): p. 5129-36).

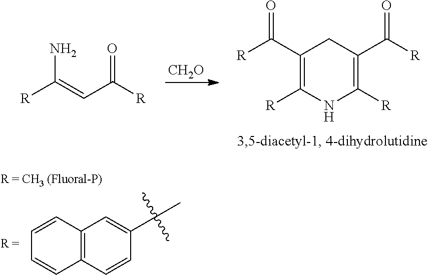

As shown in FIG. 1, the badge 100 can include an enhanced calibration area 104 with multiple colors present to improve color measurement in the app. Optionally, the multi-color calibration area is continuous. Alternatively, the multi-color calibration area includes a plurality of regions, each region having a different color or a different tint or shade of the same color.

Referring now to FIG. 2, a flowchart illustrating example operations performed by an example software application is shown. The app prompts the user to take a picture of the color changing area of the badge (e.g., badge 100 shown in FIG. 1) at step 202, for example, after the user first opens the app. The app detects the presence of contamination or other problems with the badge at step 204a and provides appropriate warnings to the user (if needed) at step 206a. The app is able to integrate several warnings to the user to ensure that the measurement is conducted properly. These include warnings about appropriate lighting conditions, potential contamination, and other interferences that might result in an inaccurate reading. The app can also help guide users to take the picture from the most optimal angle and distance at step 204b and provides appropriate instructions to the user (if needed) at step 206b.

Taking the first picture (step 202) also starts the timer at step 208 so that the user knows how long to wait to take the second picture (example: 72 hours). When the time has passed, the app notifies the user to take the second picture at step 210.

The user then takes the second picture at step 212. The app uses a multi-color calibration area on the badge to calculate the precise color of the color-changing area. This color is compared to previously-collected calibration data to calculate the concentration of the contaminant in the environment at step 214. The final reading is then be displayed to the user at step 216.

The app optionally provides information to the user to help them interpret the measured concentration in their indoor environment and determine if it might be associated with health effects. Additionally, the app optionally provides information on methods to reduce the exposure level. Users can take these actions and then test again to see if they reduced their exposure levels.

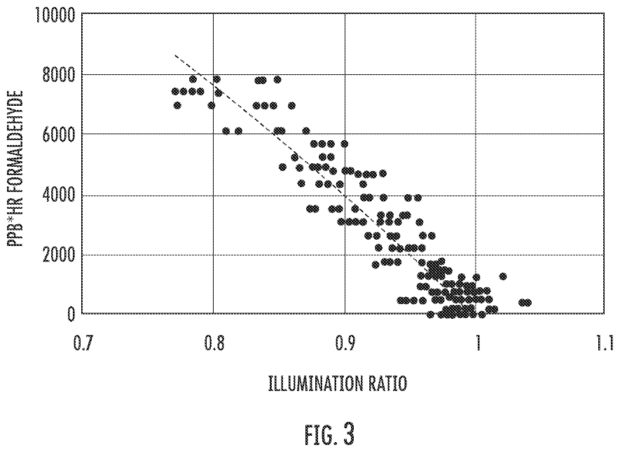

The app described herein can detect and quantify the color change on a colorimetric badge for formaldehyde detection. FIG. 3 is a graph illustrating smartphone-based results from a color-changing formaldehyde detection badge (illumination vs. concentration).

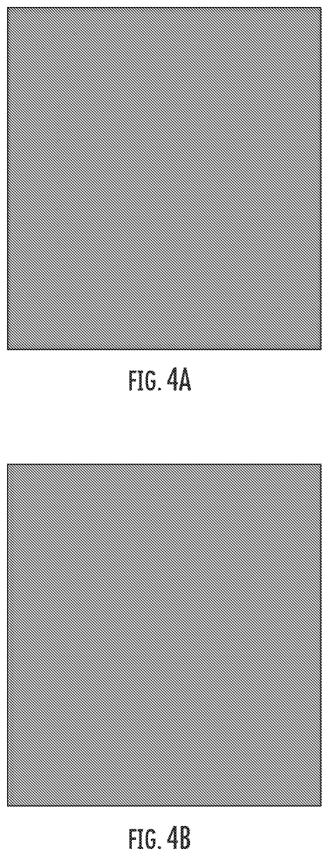

The app described herein overcomes the challenge of accurately measuring color change by using an illumination ratio calculated by comparing a color-changing area to a calibration area on the badge. For example, the app is more sensitive to badge color changes as compared to the human eye. FIGS. 4A-4B demonstrates difficulties of human visual differentiation. While the colors shown in FIGS. 4A and 4B are difficult to differentiate visually, the app described herein is able to differentiate between them. In particular, the color readings of two visually non-differentiable colors such as those shown in FIGS. 4A and 4B reflect measurable difference in one or more of hue, saturation, and luminance. The Hue/Saturation/Luminance (H/S/L) of the color in FIG. 4A are 14/99/128, while the H/S/L of the color in FIG. 4B are 13/95/128. These characteristics can be measured quantitatively by the app described herein. Environmental lighting also affects the ability to quantify badge color changes. Indoor environments make this even more difficult. The app described herein overcomes these difficulties by: (1) calculating the position and/or orientation of the color changing badge, which can be used to optimize reflectance modeling and guide users to the best position for taking an image and/or (2) calibrating to the environmental lighting conditions for accurate reflectance measurement.

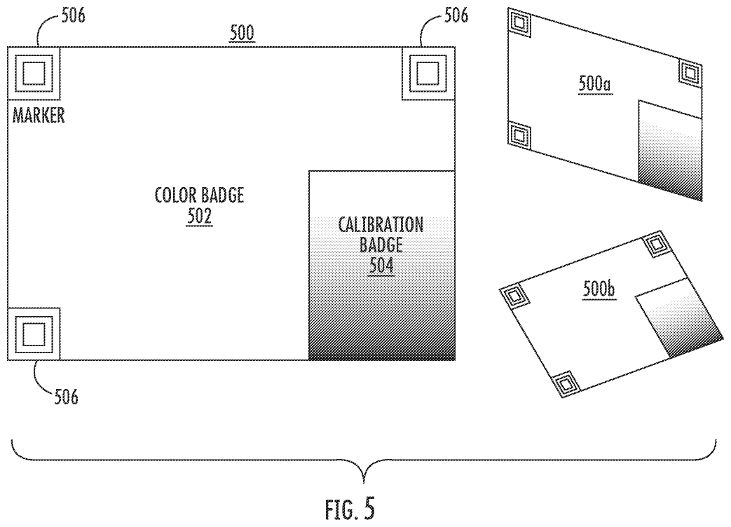

Referring now to FIG. 5, an image of another example color-changing badge 500 is shown. The badge 500 includes a reaction area 502 and a calibration area 504. In this implementation, a plurality of markers 506 (e.g., 3 QR codes) are printed in the corners of the badge 500. The markers 506 can be used to locate the badge in digital space. In some implementations, images are captured from the same angle (e.g., perpendicular to badge such that markers form square or rectangular shapes as shown by badge 500). In other implementations, images are taken at angles (e.g., such that markers form a unilateral shape as shown by badges 500a and 500b). It is possible to estimate the relationship of the markers 506 appearing in images of different angles using a homographic matrix. Thus, the app can estimate the camera position and estimate the homographic matrix. This information can be translated to a camera rotation, which can be used to guide the user, for example, to capture the image from the optimal orientation. FIG. 5 demonstrates rotation of color-changing area in space. The image of badge 500 is shown on the left, and rotations of this image in space 500a and 500b are shown at the right. Note how the outline of the markers changes shape after rotation.

The badge described herein can include a calibration area having a continuous color domain or regions with different color levels. This calibration area can be used to more accurately estimate environmental lighting models for more accurate reading recovery. Optionally, the flash on the smart phone can be used to illuminate the badge. Alternatively or additionally, this disclosure contemplates using other light sources to illuminate the badge. This includes light sources integral with the image capture device, attachable to the image capture device, or external to the image capture device. As a result, readings in different environments can be recovered more accurately and consistently. Optionally, the app controls the flashlight and can control capture of multiple images for averaging.

The term “alkyl” as used herein is a branched or unbranched hydrocarbon group such as methyl, ethyl, n-propyl, isopropyl, n-butyl, isobutyl, t-butyl, pentyl, hexyl, heptyl, octyl, nonyl, decyl, dodecyl, and the like. The alkyl group can also be substituted or unsubstituted. Unless stated otherwise, the term “alkyl” contemplates both substituted and unsubstituted alkyl groups. The alkyl group can be substituted with one or more groups including, but not limited to, alkoxy, alkenyl, alkynyl, cycloalkyl, heterocycloalkyl, aryl, heteroaryl, aldehyde, amino, carboxylic acid, ester, ether, halide, hydroxy, ketone, nitro, silyl, sulfo-oxo, phosphine or thiol. An alkyl group which contains no double or triple carbon-carbon bonds is designated a saturated alkyl group, whereas an alkyl group having one or more such bonds is designated an unsaturated alkyl group. Unsaturated alkyl groups having a double bond can be designated alkenyl groups, and unsaturated alkyl groups having a triple bond can be designated alkynyl groups. Unless specified to the contrary, the term alkyl embraces both saturated and unsaturated groups.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is replaced with a heteroatom such as, but not limited to, nitrogen, oxygen, sulfur, selenium or phosphorus. The cycloalkyl group and heterocycloalkyl group can be substituted or unsubstituted. Unless stated otherwise, the terms “cycloalkyl” and “heterocycloalkyl” contemplate both substituted and unsubstituted cycloalkyl and heterocycloalkyl groups. The cycloalkyl group and heterocycloalkyl group can be substituted with one or more groups including, but not limited to, alkyl, alkoxy, alkenyl, alkynyl, cycloalkyl, heterocycloalkyl, aryl, heteroaryl, aldehyde, amino, carboxylic acid, ester, ether, halide, hydroxy, ketone, nitro, silyl, sulfo-oxo, or thiol. A cycloalkyl group which contains no double or triple carbon-carbon bonds is designated a saturated cycloalkyl group, whereas an cycloalkyl group having one or more such bonds (yet is still not aromatic) is designated an unsaturated cycloalkyl group. Unless specified to the contrary, the term cycloalkyl embraces both saturated and unsaturated, non-aromatic, ring systems.

The term “aryl” as used herein is an aromatic ring composed of carbon atoms. Examples of aryl groups include, but are not limited to, phenyl and naphthyl, etc. The term “heteroaryl” is an aryl group as defined above where at least one of the carbon atoms of the ring is replaced with a heteroatom such as, but not limited to, nitrogen, oxygen, sulfur, selenium or phosphorus. The aryl group and heteroaryl group can be substituted or unsubstituted. Unless stated otherwise, the terms “aryl” and “heteroaryl” contemplate both substituted and unsubstituted aryl and heteroaryl groups. The aryl group and heteroaryl group can be substituted with one or more groups including, but not limited to, alkyl, alkoxy, alkenyl, alkynyl, cycloalkyl, heterocycloalkyl, aryl, heteroaryl, aldehyde, amino, carboxylic acid, ester, ether, halide, hydroxy, ketone, nitro, silyl, sulfo-oxo, or thiol.

Exemplary heteroaryl and heterocyclyl rings include: benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyL cirrnolinyl, decahydroquinolinyl, 2H,6H^{˜} 1,5,2-dithiazinyl, dihydrofuro[2,3 b]tetrahydrofuran, furanyl, furazanyl, imidazolidinyl, imidazolinyl, imidazolyl, IH-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl, and xanthenyl.

The terms “alkoxy” and “alkoxyl” as used herein to refer to an alkyl or cycloalkyl group bonded through an ether linkage; that is, an “alkoxy” group can be defined as —OA¹ where A¹ is alkyl as defined above. “Alkoxy” also includes polymers of alkoxy groups as just described; that is, an alkoxy can be a polyether such as —OA¹-OA² or -OA¹-(OA²)ₐ-OA³, where “a” is an integer of from 1 to 200 and A¹, A², and A³ are alkyl groups.

The terms “cycloalkoxy,” “heterocycloalkoxy,” “cycloalkoxy,” “aryloxy,” and “heteroaryloxy” have the aforementioned meanings for alkyl, cycloalkyl, heterocycloalkyl, aryl and heteroaryl, further providing said group is connected via an oxygen atom.

As used herein, the term “null,” when referring to a possible identity of a chemical moiety, indicates that the group is absent, and the two adjacent groups are directly bonded to one another. By way of example, for a genus of compounds having the formula CH₃—X—CH₃, if X is null, then the resulting compound has the formula CH₃—CH₃.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. Unless specifically stated, a substituent that is said to be “substituted” is meant that the substituent can be substituted with one or more of the following: alkyl, alkoxy, alkenyl, alkynyl, cycloalkyl, heterocycloalkyl, aryl, heteroaryl, aldehyde, amino, carboxylic acid, ester, ether, halide, hydroxy, ketone, nitro, silyl, sulfo-oxo, phosphine, or thiol. In a specific example, groups that are said to be substituted are substituted with a protic group, which is a group that can be protonated or deprotonated, depending on the pH.

Suitable salts are salts that retain the desired detection activity of the parent compound and do not impart undesirable toxicological effects. Examples of such salts are acid addition salts formed with inorganic acids, for example, hydrochloric, hydrobromic, sulfuric, phosphoric, and nitric acids and the like; salts formed with organic acids such as acetic, oxalic, tartaric, succinic, maleic, fumaric, gluconic, citric, malic, methanesulfonic, p-toluenesulfonic, napthalenesulfonic, and polygalacturonic acids, and the like; salts formed from elemental anions such as chloride, bromide, and iodide; salts formed from metal hydroxides, for example, sodium hydroxide, potassium hydroxide, calcium hydroxide, lithium hydroxide, and magnesium hydroxide; salts formed from metal carbonates, for example, sodium carbonate, potassium carbonate, calcium carbonate, and magnesium carbonate; salts formed from metal bicarbonates, for example, sodium bicarbonate and potassium bicarbonate; salts formed from metal sulfates, for example, sodium sulfate and potassium sulfate; and salts formed from metal nitrates, for example, sodium nitrate and potassium nitrate. Pharmaceutically acceptable and non-pharmaceutically acceptable salts may be prepared using procedures well known in the art, for example, by reacting a sufficiently basic compound such as an amine with a suitable acid comprising a physiologically acceptable anion. Alkali metal (for example, sodium, potassium, or lithium) or alkaline earth metal (for example, calcium) salts of carboxylic acids can also be made.

It should be appreciated that the logical operations described herein with respect to the various figures may be implemented (1) as a sequence of computer implemented acts or program modules (i.e., software) running on a computing device (e.g., the computing device described in FIG. 6), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 6, an example computing device 600 upon which the methods described herein may be implemented is illustrated. It should be understood that the example computing device 600 is only one example of a suitable computing environment upon which the methods described herein may be implemented. Optionally, the computing device 600 can be a well-known computing system including, but not limited to, personal computers, servers, handheld, tablet, or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 600 typically includes at least one processing unit 606 and system memory 604. Depending on the exact configuration and type of computing device, system memory 604 may be volatile (such as random access memory (RAM)), non-volatile (such as read-only memory (ROM), flash memory, etc.), or some combination of the two. This most basic configuration is illustrated in FIG. 6 by dashed line 602. The processing unit 606 may be a standard programmable processor that performs arithmetic and logic operations necessary for operation of the computing device 600. The computing device 600 may also include a bus or other communication mechanism for communicating information among various components of the computing device 600.

Computing device 600 may have additional features/functionality. For example, computing device 600 may include additional storage such as removable storage 608 and non-removable storage 610 including, but not limited to, magnetic or optical disks or tapes. Computing device 600 may also contain network connection(s) 616 that allow the device to communicate with other devices. Computing device 600 may also have input device(s) 614 such as a keyboard, mouse, touch screen, etc. Output device(s) 612 such as a display, speakers, printer, etc. may also be included. The additional devices may be connected to the bus in order to facilitate communication of data among the components of the computing device 600. All these devices are well known in the art and need not be discussed at length here.

The processing unit 606 may be configured to execute program code encoded in tangible, computer-readable media. Tangible, computer-readable media refers to any media that is capable of providing data that causes the computing device 600 (i.e., a machine) to operate in a particular fashion. Various computer-readable media may be utilized to provide instructions to the processing unit 606 for execution. Example tangible, computer-readable media may include, but is not limited to, volatile media, non-volatile media, removable media and non-removable media implemented in any method or technology for storage of information such as computer readable instructions, data structures, program modules or other data. System memory 604, removable storage 608, and non-removable storage 610 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 606 may execute program code stored in the system memory 604. For example, the bus may carry data to the system memory 604, from which the processing unit 606 receives and executes instructions. The data received by the system memory 604 may optionally be stored on the removable storage 608 or the non-removable storage 610 before or after execution by the processing unit 606.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

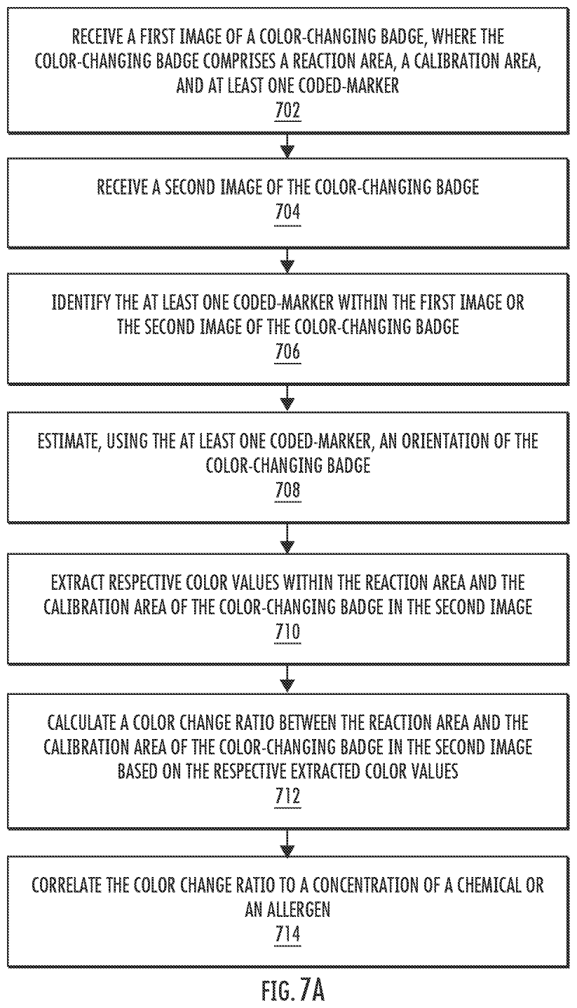

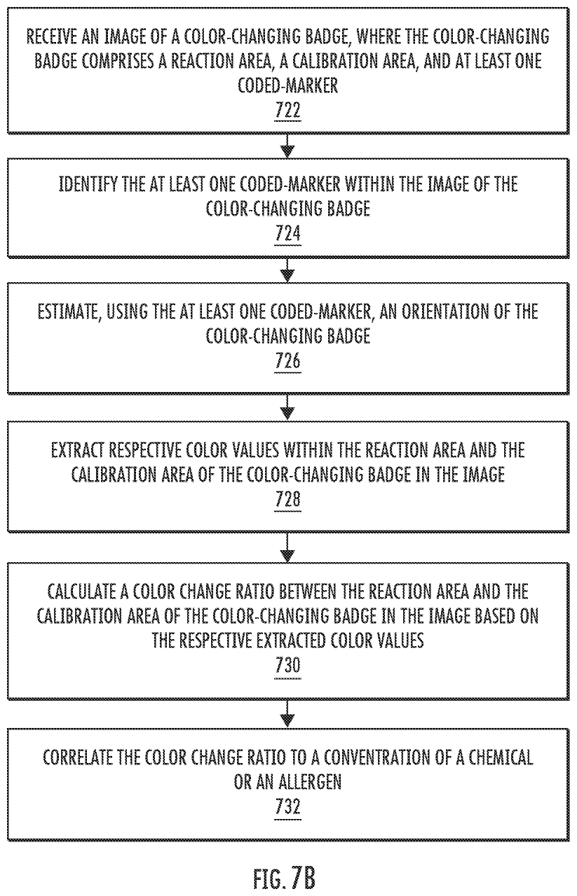

Referring now to FIG. 7A, an example method for estimating chemical or allergen concentration in an environment is described. In some implementations described herein, the chemical is formaldehyde. It should be understood that the method described herein can be used to estimate concentration of a chemical other than formaldehyde. In other implementations, the target of interest may be an allergen, such as one from cockroaches, dust mites (Dermatophogoides pteronyssinus and D. farina), mice, mold, cats, dogs, or rats. It should be understood that the method described herein can be used to estimate concentration of an allergen from a source other than cockroaches, dust mites, mice, mold, cats, dogs, or rats. In other words, this disclosure contemplates that the method described herein is not limited for use with formaldehyde or allergens from cockroaches, dust mites, mice, or mold. Additionally, the environment can optionally be an indoor environment. This disclosure contemplates that indoor environments include, but are not limited to, homes, schools, hospitals, offices, workplaces, government buildings, public locations, or other enclosed spaces. It should be understood that it is difficult, if not impossible, to directly measure exposure to chemicals and/or allergens, particularly in indoor environments. Barriers to such measurements include, but are not limited to, physical access to the environment (e.g., privacy concerns), equipment costs and/or access, having multiple locations within a given environment, having people move between different environments, and test protocols. Targets of interest can be measured from different locations in the indoor environment, including but not limited to air, surfaces, settled dust, water, or airborne dust. The method described herein addresses these concerns, for example, by facilitating implementation on a portable computing device, which is widely available to the general public. This disclosure contemplates that the device can be used by professionals or by individuals.

This disclosure contemplates that the method can be implemented on a computing device (e.g., computing device 600 of FIG. 6) including, but not limited to, a portable computing device such as smartphone or tablet. This disclosure contemplates that the method can optionally be implemented by a mobile app executed by a computing device in some implementations. As described herein, the method is able to detect and quantify the color change on a color-changing badge for chemical and/or allergen detection. Accurately quantifying color (e.g., hue, saturation, and/or luminance values) of a color-changing badge using digital image processing is a difficult task. For example, color detection is effected by the lighting conditions. Moreover, the impact of lighting conditions is very significant in indoor environments, where objects create complex light refraction, reflection, occlusion, and shadows. The method described herein addresses these concerns, for example, by providing user guidance for optimal image capture and/or using appropriate lighting models. This allows for measurement of color that exceeds the ability of the human eye.

At step 702, a first image of a color-changing badge is received. Example color-changing badges are described herein, for example, with reference to FIGS. 1 and 5. At step 704, a second image of the color-changing badge is received. In some implementations, the second image is received after the first image (e.g., after expiration of a predetermined period of time). As described herein, in some implementations, capturing the first image initiates the beginning of an exposure period. Alternatively or additionally, the first image is analyzed to check the color-changing badge for issues such as contamination before proceeding with exposure and/or further analysis. In the event of contamination, a new color-changing badge can be substituted and used for the test. Additionally, although two images are received in the example operations of FIG. 7A, this disclosure contemplates that chemical or allergen concentration can be estimated using one image (see e.g., the operations of FIG. 7B).

Optionally, the first and/or second image are captured by a portable computing device such as a smartphone. In some implementations, a timer is initiated in response to receiving the first image of the color-changing badge. The timer is used to measure a predetermined exposure period, and after expiration of the exposure period, an exposure notification is provided to a user. The exposure notification can include permission to capture the second image. During the exposure period, the color-changing badge is exposed to a contaminant in the air such as formaldehyde. In some implementations, for example when the chemical contaminant is formaldehyde, the predetermined exposure period is at least 12 hours and optionally about 72 hours. This disclosure contemplates that the length of the predetermined exposure period is dependent on the chemical contaminant of interest.

As described above, the color-changing badge can include a reaction area, a calibration area, and at least one coded-marker. Example color-changing badges are shown for example in FIGS. 1 and 5. It should be understood that the color-changing badge is exposed to the environment during the time interval between capture of the first and second images. Accordingly, the color-changing badge is exposed to a chemical (e.g., formaldehyde), which cause the reaction area of the color-changing badge to change colors. Additionally, this disclosure contemplates that the coded-marker can be a machine-readable fiducial marker that is capable of being recognized using a pattern recognition algorithm. For example, the coded-marker can be a barcode such as a two-dimensional barcode (QR code) in some implementations. This disclosure contemplates that the color-changing badge can be one of the sensors or badges described herein.

At step 706, the coded-markers within the first image and the second image of the color-changing badge are identified. The coded-markers are machine-readable optical labels such as 1D, 2D, or 3D codes. This disclosure contemplates that the coded-markers can be identified using imaging processing techniques such as contour-based, Bin-based and topology-based marker detection followed by robust estimation techniques such template matching, correlation, etc. It should be understood that the image processing and robust estimation techniques provided above are only examples. This disclosure contemplates using other image processing and/or robust estimation techniques that are known in the art with the methods described herein. The coded-markers are used to locate the color-changing badge in a virtual digital space. For example, the coded-markers can be provided on a plurality (e.g., 3 or more) corners of the color-changing badge as shown in FIGS. 1 and 5. Then, at step 708, the position and orientation of the color-changing badge is estimated in relation to the image capture device (e.g. smartphone) based the coded-markers. For example, when an image is captured perpendicular to the color-changing badge (see e.g., badge 500 in FIG. 5), the coded-markers are expected to form a known shape (e.g., rectangle or square). If, however, an image is captured at a slanted angle (see e.g., images 500a, 500b in FIG. 5), the coded-markers will form a unilateral shape. This is based on affine geometry. Image processing algorithms can be used to estimate the relationship between the coded-markers. For example, homographic transformations can be used to estimate the position and orientation of the color-changing badge in relation to the image capture device (e.g., smartphone). It should be understood that homographic transformation are provided only as a non-limiting example. Starting from the position of the image capture device, it is possible to estimate the current position of the image capture device and the homographic matrix, which translates to image capture device rotation. Using this information, guidance can be provided to the user, e.g., instructions to move the image capture device into an optimal position and orientation for image capture. In some implementations, such instructions can be arrows or other graphical display provided on the screen of the image capture device. The relative position differences guide the user to orient the image capture device to the similar view point between the first and the second images. Ensuring that the first and/or second images are taken with similar view point improves performance of color detection in environments with uncontrolled lighting condition.

At step 710, respective color values within the reaction area and the calibration area of the color-changing badge in the second image are extracted. This includes the values for hue, saturation, and/or luminance of the pixels in the reaction and calibration areas. As discussed above, pixel values of two visually non-differentiable badges may reflect measurable difference in one or more of hue, saturation, and luminance (see e.g., FIGS. 4A and 4B). The method described herein therefore provides an advantage over visual differentiation by extracting color values from the images. Then, at step 712, a color change ratio between the reaction area and the calibration area of the color-changing badge in the second image is calculated based on the respective extracted color values. In some implementations, the color change ratio (crr) is calculated using the following formula:

$$c r = \frac{{l}_{r}}{{l}_{c}} ,$$

where, cr refers to the color ratio; lᵣ and l_{c} respectively refer to the illumination value in the reaction and calibration areas. And crr is defined as the differences of cr before and after the exposure to the contaminant. It should be understood that the crr formula provided above is only an example. This disclosure contemplates using other techniques to calculate a color change ratio between the reaction area and the calibration area of the color-changing badge.

At step 714, the color change ratio is correlated to a concentration of a chemical or allergen. It should be understood that the correlation function and coefficients are chemical or allergen specific. The correlation function and coefficients are determined by laboratory test in the badge designing process. For example, calibration can be completed by exposing badges to known concentrations of the chemical or allergen, measuring the color change ratio, and calculating the best-fit line to compare these two variables. In some implementations, the calibration area of the color-changing badge can optionally be a multi-color calibration area. Optionally, the multi-color calibration area is continuous. Alternatively, the multi-color calibration area includes a plurality of regions, each region having a different color or a different tint or shade of the same color.

In some implementations, the method can optionally include validating respective colorimetric ranges for the reaction area and the calibration area of the color-changing badge. The validation step can be performed using the first image. The validation step tests if the initial badge (e.g., the color-changing badge in the first image) exhibits color change that exceeds normal ranges, which is pre-defined through a laboratory experiment. The illumination value of the color-changing area (e.g., the reaction area) on the color-changing badge in the image is calculated and compared to the illumination value of the calibration area. If the ratio exceeds a pre-determined value, then a warning is issues to the user to check the color-changing badge for contamination.

In some implementations, the method can optionally include providing a notification to a user. The notification can include instructions for capturing at least one of the first image or the second image of the color-changing badge. The instructions can be based on the estimated orientation of the color-changing badge. For example, the instructions can include at least one of an optimal angle or distance for image capture. Alternatively or additionally, the instructions can include a recommendation to use active lighting (e.g., activating a light or flash of the image capture device).

In some implementations, the method can optionally include providing a concentration notification to a user, where the concentration notification includes the concentration of the chemical or allergen. Optionally, the concentration notification can further include a health risk associated with the concentration of the chemical or allergen or instructions for reducing the concentration of the chemical or allergen.

In some implementations, the method can optionally include providing a warning notification to a user, where the warning notification includes information about a condition that impacts accuracy of the correlation. The condition that impacts accuracy of the correlation can include, but is not limited to, lighting, image quality, contamination, camera view direction or a combination thereof.

Referring now to FIG. 7B, another example method for estimating chemical or allergen concentration in an environment is described. As described above, in some implementations, the chemical is formaldehyde. In other implementations, the allergen is from cockroaches, dust mites, mice, mold, dogs, cats, rats, or others. It should be understood that formaldehyde and allergens from cockroaches, dust mites, mice, mold, dogs, cats, or rats are only provided as examples.

This disclosure contemplates that the method can be implemented on a computing device (e.g., computing device 600 of FIG. 6) including, but not limited to, a portable computing device such as smartphone or tablet, which are provided only as examples. The method described herein is able to detect and quantify the color change on a color-changing badge for chemical and/or allergen detection. As described below, and unlike the operations of FIG. 7A, the operations of FIG. 7B can detect and quantify the color change on a color-changing badge for chemical and/or allergen detection using a single image.

At step 722, an image of a color-changing badge is received. Example color-changing badges are described herein, for example, with reference to FIGS. 1 and 5. As described above, the color-changing badge can include a reaction area, a calibration area, and at least one coded-marker. It should be understood that the color-changing badge has been exposed to the environment or sample prior to image capture. In this way, the contaminant has reacted with the reaction area of the badge, which cause a color change. At 724, the at least one coded-marker within the image of the color-changing badge is identified. The coded-markers are machine-readable optical labels such as 1D, 2D, or 3D codes. This disclosure contemplates that the coded-markers can be identified using imaging processing techniques known in the art. The coded-markers are used to locate the color-changing badge in a virtual digital space. For example, the coded-markers can be provided on a plurality (e.g., 3 or more) corners of the color-changing badge as shown in FIGS. 1 and 5. Then, at step 726, an orientation of the color-changing badge is estimated based on the at least one coded-marker. As described above, image processing algorithms can be used to estimate the relationship between the coded-markers. Such algorithms may include, but are not limited to, homographic transformations. Depending on the orientation, instructions can optionally be provided to the user to recapture the image of the badge at a more optimal distance and/or angle. At step 728, respective color values within the reaction area and the calibration area of the color-changing badge in the image are extracted. This includes the values for hue, saturation, and/or luminance of the pixels in the reaction and calibration areas. Then, at step 730, a color change ratio between the reaction area and the calibration area of the color-changing badge in the image is calculated based on the respective extracted color values. In some implementations, this is accomplished using the color change ratio (crr) formula described herein. At step 732, the color change ratio is correlated to a concentration of a chemical or allergen. It should be understood that the correlation function and coefficients are chemical or allergen specific. As described above, the correlation function and coefficients are determined by laboratory test in the badge designing process.

In some implementations, the reaction area can include at least one reporter compound and a substrate. Generally, the substrate is a film or sheet having a first and second face. In some instances, the second face is affixed to the badge, and the first face is viewable by a user. In other embodiments, the substrate is housed within the badge and both the first and second face are viewable by a user through a window of the badge. The reporter compound can be absorbed, coated, or impregnated into the substrate, or the reporter compound may be covalently bonded to the substrate. In some embodiments, the reporter compound is homogenously dispersed throughout the substrate, meaning that the reporter compound is present in uniform concentrations throughout the bulk of the substrate. In other embodiments, the reported compound is coated onto the substrate, meaning that the reporter compound is present on one or more surfaces, but does not substantially penetrate the bulk of the substrate. In yet further embodiments, the reporter compound is impregnated into the substrate, meaning that the concentration of the reporter compound varies along a gradient throughout the bulk of the substrate. In some instances, when both the first and second face of the substrate are viewable by a user, having different reporter concentrations at each face allows further calibration of the target analyte.

In certain implementations, the reporter compound can be a compound having the formula:

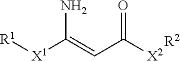

wherein

X¹ and X² are independently selected from null, O, S, and NR³;

R¹ and R² are independently selected from C₁₋₈alkyl, aryl, C₁₋₈heteroaryl, C₁₋₈heterocyclyl, or linker conjugated to the substrate;

R³ is in each case independently selected from H, C₁₋₈alkyl, aryl, C₁₋₈heteroaryl, C₁₋₈heterocyclyl,

wherein any of said alkyl, aryl, heteroaryl, and heterocyclyl groups may be conjugated to the substrate through a linker, and/or substituted one or more times by OH, NH₂, SO₃X³, NO₂, PO₃X³, wherein X³ is H or acceptable cation, present in the stoichiometric amount needed for electroneutrality.

In some implementations, X¹ and X² are each null.

In certain implementations, R¹ and R² are the same, for instance R¹ and R² are each C₁₋₄alkyl (e.g., methyl, ethyl, n-propyl, iso-propyl, n-butyl, sec-butyl, isobutyl, or tert-butyl), phenyl or naphthyl. When R¹ aryl or heteroaryl, said aryl and heteroaryl groups may be substituted with one, two, three, or four SO₃X³, groups, one, two, three, or four NH₂, groups, or a combination of both SO₃X³ and NH₂, groups.

In some implementations, the substrate can be a cellulosic material, for instance a paper. The cellulosic substrate can be further functionalized with hydrophilic or hydrophobic groups as known in the art. Suitable functionalized cellulosic substrates include ethyl cellulose, cellulose acetate, hydroxypropyl methylcellulose, carboxymethyl cellulose and the like. The reporter compound can be present in an amount of less than 5% by weight, less than 2.5% by weight, less than 1% by weight, less than 0.5% by weight, or less than 0.1% by weight, relative to the weight of the substrate.

In certain embodiments, the reporter compound can be combined with the substrate by comprising submerging the substrate in a solution or dispersion of the reporter compound, or spraying, painting, or coating a solution or dispersion of the reporter compound on at least one surface of the substrate. By submerging the substrate in said solution, the reporter compound can be uniformly dispersed through the bulk of the substrate. By spraying, painting, or otherwise coating the reporter compound onto a surface of the substrate, the reporter compound can either be coated or impregnated into the substrate, depending on the permeability of the solvent to the substrate.

In certain implementations, the reporter compound can be covalently conjugated to the substrate using known methods. For instance, in cases of cellulosic substrate, the C-6 hydroxyl group may be covalently linked to the reporter compound:

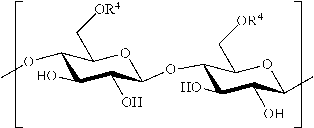

wherein R⁴ is in each case independently selected from H and a group having the formula:

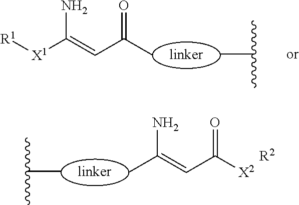

Suitable linkers include polyethylene glycols, for instance:

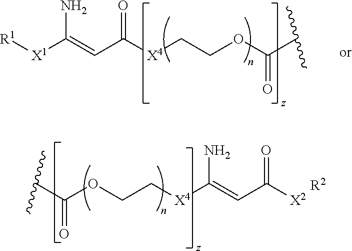

wherein X⁴ is independently selected from null, O, S, and NH, n is independently selected from 1-10, and z is independently selected from 0 or 1. R⁴ can be H in at least 5% of occurrences, at least 10% of occurrences, at least 25% of occurrences, at least 50% of occurrences, at least 75% of occurrences, or at least 90% of occurrences. In the case of functionalized cellulose, R⁴ can be a mixture of H, reporter compounds as defined above, and further functional group like C₁₋₄alkyl, C₁₋₄ hydroxyalkyl, C(O)C₁₋₄alkyl, or C₁₋₄alkylCO₂H.

In some aspects, the systems and methods of the present disclosure may be used to detect airborne or settled particulates/allergens and other environmental allergens. Thus in another aspect, a sensor is provided for detecting an allergen comprising a composite material, the composite material comprising a nanofibrous substrate and an antibody with specificity for the allergen encapsulated within the nanofibrous substrate.

The allergens may be sourced from plants (e.g. weeds, grasses, trees, pollens), animals (e.g., allergens found in the dander, urine, saliva, blood or other bodily fluid of mammals such as cat, dog, cow, pig, sheep, horse, rabbit, rat, guinea pig, mouse and gerbil), fungi/mold, insects (e.g., stinging insects such as bee, wasp, and hornet and chirnomidoe (non-biting midges), as well as other insects such as the housefly, fruit fly, sheep blow fly, screw worm fly, grain weevil, silkworm, honeybee, non-biting midge larvae, bee moth larvae, mealworm, cockroach and larvae of Tenibrio molitor beetle; spiders and mites such as the house dust mite), rubbers (e.g. latex), metals, chemicals (e.g. drugs, protein detergent additives) and autoallergens and human autoallergens (e.g. Hom s 1, Hom s 2, Hom s 3, Hom s 4, Hom s 5). The names of allergens are systematically named and listed according to IUIS Allergen Nomenclature Sub-Committee (see, International Union of Immunological Societies Allergen Nomenclature Sub-Committee, List of isoallergens and variants.)

Examples of allergenic proteins from plants that can be detected using the systems and processes of the present disclosure include, but are not limited to, ash (Fra e 1), Japanese cypress (Cha 01, Cha o 2), sugi (Cry j1, Cry j 2), cypress (Cup a 1), common cypress (Cup s 1, Cup s 3), mountain cedar (Jun a 1, Jun a 2, Jun a 3, Jun s 1), prickly juniper (Jun o 4), eastern red cedar (Jun v 1, Jun v 3), sweet vernal grass (Ant o 1), saffron crocus (Cro s 1, Cro s 2), Bermuda grass (Cyn d 1, Cyn d 7, Cyn d 12, Cyn d 15, Cyn d 22w, Cyn d 23, Cyn d 24), orchard grass (Dac g 1, Dac g 2, Dac g 3, Dac g 4, Dac g 5), meadow fescue (Fes p 4), velvet grass (Hol l 1, Hol l 5), barley (Hor v 1, Hor v 5), rye grass (Lol p 1, Lol p 2, Lol p 3, Lol p 4, Lol p 11), bahia grass (Pas n 1), canary grass (Pha a 1, Pha a 5), timothy (PhI p 1, Phi p 2, PhI p 4, Phi p 5, PhI p 6, Phi p 7, PhI p 11, PhI p 12, Phi p 13), date palm (Pho d 2), Kentucky blue grass (Poa p 1, Poa p 5), rye (Sec c 1, Sec c 5, Sec c 38), Johnson grass (Sor h 1), wheat (Tri a 15, Tri a 21, Tri a 27, Tri a 28, Tri a 29, Tri a 30, Tri a 31, Tri a 32, Tri a 33, Tri a 34, Tri a 35, Tri a 39), maize (Zea m 1, Zea m 12), alder (Aln g 1, Aln g 4), redroot pigweed (Ama r 2), short ragweed (Amb a 1, Amb a 2, Amb a 3, Amb a 4, Amb a 5, Amb a 6, Amb a 7, Amb a 8, Amb a 9, Amb a 10, Amb a 11), western ragweed (Amb p 5), giant ragweed (Amb t 5), mugwort (Art v 1, Art v 2, Art v 3, Art v 4, Art v 5, Art v 6), sugar beet (Beta v 1, beta v 2), European white birch (Bet v 1, Bet v 2, Bet v 3, Bet v 4, Bet v 6, Bet v 7), turnip (Bra r 5), hornbeam (Car b 1), chestnut (Cas s 1), rosy periwinkle (Cat r 1), lamb's-quarters, pigweed (Che a 1, Che a 2, Che a 3), Arabian coffee (Cof a 1, Cof a 2, Cof a 3), Hazel (Cor a 6, Cor a 10), Hazel nut (Cor a1.04, Cor a2, Cor a8), European beech (Fag s 1), ash (Fra e 1), sunflower (Hel a 1, Hel a 2), para rubber tree (Hey b 1, Hey b 2, Hey b 3, Hey b 4, Hey b 5, Hey b 6, Hey b 7, Hey b 8, Hey b 9, Hey b 10, Hey b 11, Hey b 12, Hey b 13, Hey b 14), Japanese hop (Hum j 1), privet (Lig v 1), Mercurialis annua (Mer a 1), olive (Ole e 1, Ole e 2, Ole e 3, Ole e 4, Ole e 5, Ole e 6, Ole e 7, Ole e 8, Ole e 9, Ole e 10, Ole e 11), European hophornbeam (Ost c 1), Parietaria judaica (Par j 1, Par j 2, Par j 3, Par j 4), Parietaria officinalis (Par o 1), Plantago lanceolata (Pal l 1), London plane tree (Pla a 1, Pla a 2, Pla a 3), Platanus orientalis (Pla or 1, Pla or 2, Pla or 3), white oak (Que a 1), Russian thistle (Sal k 1, Sal k 2, Sal k 3, Sal k 4, Sal k 5), tomato (Sola l 5), Lilac (Syr v 1, Syr v 5), Russian-thistle (Sal k 1), English plantain (Pla 11), Ambrosia artemisiifolia (Amb a8.0101, Amb a8.0102, Amb a9.0101, Amb a9.0102), Plantago lanceolata (Pla 11.0101, Pla 11.0102, Pla 11.0103), Parietaria judaica (Par j 3.0102), Cynodon dactylon (Cyn d1.0101, Cyn d1.0102, Cyn d1.0103, Cyn d1.0104, Cyn d1.0105, Cyn d1.0106, Cyn d1.0107, Cyn d1.0201, Cyn d1.0202, Cyn d1.0203, Cyn d1.0204), Holcus lanatus (Hol 11.0101, Hol 11.0102), Lolium perenne (Phi p1.0101, Phi p1.0102, Phi p4.0101, Phi p4.0201, Phi p5.0101, Phi p5.0102, Phi p5.0103, Phi p5.0104, Phi p5.0105, Phi p5.0106, Phi p5.0107, Phi p5.0108, Phi p5.0201, Phi p5.0202), Secale cereale (Sec c20.0101, Sec c20.0201), Betula Verrucosa (Bet v1.0101, Bet v1.0102, Bet v 1.0103, Bet v 1.0201, Bet v 1.0301, Bet v1.0401, Bet v 1.0402, Bet v 1.0501, Bet v 1.0601, Bet v 1.0602, Bet v1.0701, Bet v1.0801, Bet v1.0901, Bet v1.1001, Bet v1.1101, Bet v1.1201, Bet v 1.1301, Bet v1.1401, Bet v1.1402, Bet v1.1501, Bet v1.1502, Bet v1.1601, Bet v1.1701, Bet v 1.1801, Bet v1.1901, Bet v1.2001, Bet v1.2101, Bet v1.2201, Bet v1.2301, Bet v1.2401, Bet v 1.2501, Bet v1.2601, Bet v1.2701, Bet v1.2801, Bet v1.2901, Bet v1.3001, Bet v1.3101, Bet v 6.0101, Bet v6.0102), Corpinus betulus (Car b1.0101, Car b1.0102, Car b1.0103, Car b1.0104, Car b1.0105, Car b1.0106, Car b1.0106, Car b1.0106, Car b1.0106, Car b1.0107, Car b1.0107, Car b1.0108, Car b1.0201, Car b1.0301, Car b1.0302), Corylus avellana (Cor a1.0101, Cor a1.0102, Cor a1.0103, Cor a1.0104, Cor a1.0201, Cor a1.0301, Cor a1.0401, Cor a1.0402, Cor a1.0403, Cor a1.0404), Ligustrum vulgare (Syr v1.0101, Syr v1.0102, Syr v1.0103), Cryptomeria japonica (Cry j2.0101, Cry j2.0102), Cupressus sempervirens (Cup s1.0101, Cup s1.0102, Cup s1.0103, Cup s1.0104, Cup s1.0105), and Arachis hypogoea (Ara h 1, Ara h 2, Ara h 3, Ara h 4, Ara h 5, Ara h 6, Ara h 7, Ara h 8, Ara h 9, Ara h 10, Ara h 11, Ara h 12, Ara h 13); and any variants thereof.

Examples of allergenic proteins from mites that can be detected using the systems and processes of the present disclosure include, but are not limited to, mite (Blo t 1, Blo t 3, Bio t 4, Blo t 5, Blo t 6, Blo t 10, Blo t 11, Blo t 12, Bio t 13, Blo t 19, Blot t 21); American house dust mite (Der f 1, Der f 2, Der f 3, Der f 7, Der f 10, Der f 11, Der f 13, Der f 14, Der f 15, Der f 16, Der f 17, Der f 18, Der f 22, Der f 24); Dermatophagoides microceras (house dust mite) (Der m 1); European house dust mite (Der p 1, Der p 2, Der p 3, Der p 4, Der p 5, Der p 6, Der p 7, Der p 8, Der p 9, Der p 10, Der p 11, Der p 14, Der p 15, Der p 20, Der p 21, Der p 23); Euroglyphus maynei (House dust mite) (Eur m 2, Eur m 2, Eur m 3, Eur m 4, Eur m 14); storage mite (Aca s 13, Gly d 2, Lep d 2, Lep d 5, Lep d 7, Lep d 10, Lep d 13, Tyr p 2, Tyr p 3, Tyr p 10, Tyr p 13, Tyr p 24), Dermatophagoides farinae (Der f1.0101, Der f1.0102, Der f1.0103, Der f1.0104, Der f1.0105, Der f2.0101, Der f2.0102, Der f2.0103, Der f2.0104, Der f2.0105, Der f2.0106, Der f2.0107, Der f2.0108, Der f2.0109, Der f2.0110, Der f2.0111, Der f2.0112, Der f2.0113, Der f2.0114, Der f2.0115, Der f2.0116, Der f2.0117), Dermatophagoides pteronyssinus (Der p1.0101, Der p1.0102, Der p1.0103, Der p1.0104, Der p1.0105, Der p1.0106, Der p1.0107, Der p1.0108, Der p1.0109, Der p1.0110, Der p1.0111, Der p1.0112, Der p1.0113, Der p1.0114, Der p1.0115, Der p1.0116, Der p1.0117, Der p1.0118, Der p1.0119, Der p1.0120, Der p1.0121, Der p1.0122, Der p1.0123, Der p2.0101, Der p2.0102, Der p2.0103, Der p2.0104, Der p2.0105, Der p2.0106, Der p2.0107, Der p2.0108, Der p2.0109, Der p2.0110, Der p2.0111, Der p2.0112, Der p2.0113), Euroglyphus maynei (Eur m2.0101, Eur m2.0102), Lepidoglyphus destructor (Lep d2.0101, Lep d2.0101, Lep d2.0101, Lep d2.0102, Lep d2.0201, Lep d2.020) and Glycyphagus domesticus (Gly d2.0101, Gly d2.0201); and any variants thereof.

Examples of allergenic proteins from animals that can be detected using the systems and processes of the present disclosure include, but are not limited to, domestic cattle (Bos d 2, Bos d 3, Bos d 4, Bos d 5, Bos d 6, Bos d 7, Bos d 8), dog (Can f 1, Can f 2, Can f 3, Can f 4, Can f 5, Can f 6), domestic horse (Equ c 1, Equ c 2, Equ c 3, Equ c 4, Equ c 5), cat (Fel d 1, Fel d 2, Fel d 3, Fel d 4, Fel d 5w, Fel d 6w, Fel d 7, Fel d 8), mouse (Mus m 1), guinea pig (Cav p 1, Cav p 2, Cav p 3, Cav p 4, Cav p 6), rabbit (Ory c 1, Ory c 3, Ory c 4) rat (Rat n 1), Bos domesticus (Bos d 2.0101, Bos d 2.0102, Bos d 2.0103) and Equus caballus (Equ c2.0101, Equ c 2.0102); and any variants thereof.

Examples of allergenic proteins from insects that can be detected using the systems and processes of the present disclosure include, but are not limited to, yellow fever mosquito (Aed a 1, Aed a 2, Aed a 3), Eastern hive bee (Api c 1), giant honeybee (Api d 1), honey bee (Api m 1, Api m 2, Api m 3, Api m 4, Api m 5, Api m 6, Api m 7, Api m 8, Api m 9, Api m 10, Api m 11, Api m 12), pigeon tick (Arg r 1), German cockroach (Bla g 1, Bla g 2, Bla g 3, Bla g 4, Bla g 5, Bla g 6, Bla g 7, Bla g 8, Bla g 11), bumble bee (Bom p 1, Bom p 4, Bom t 1, Bom t 4), silk moth (Bomb m 1), midge (Chi k 10, Chi t 1, Chi t 1.01, Chi t 2, Chi t 2.0101, Chi t 2.0102, Chi t 3, Chi t 4, Chi t 5, Chi t 6, Chi t 6.01, Chi t 7, Chi t 8, Chi t 9), cat flea (Cte f 1, Cte f 2, Cte f 3), yellow hornet (Dol a 5), white face hornet (Dol m 1, Dol m 2, Dol m 5), biting midge (For t 1, For t 2), Savannah Tsetse fly (Glo m 5), Asian ladybeetle (Har a 1, Har a 2), silverfish (Lep s 1), booklouse (Lip b 1), Australian jumper ant (Myr p 1, Myr p 2, Myr p 3), American cockroach (Per a 1, Per a 3, Per a 6, Per a 7, Per a 9, Per a 10), Indian meal moth (Plo i 1, Plo i 2), wasp (Pol a 1, Pol a 2, Pol a 5, Pol e 1, Pol e 4, Pol e 5, Pol f 5, Pol g 1, Pol g 5, Pol m 5, Poly p 1, Poly s 5, Ves vi 5), Mediterranean paper wasp (Pol d 1, Pol d 4, Pol d 5), tropical fire ant (Sol g 2, Sol g 3, Sol g 4), Solenopsis invicto (red imported fire ant) (Sol l 1, Sol l 2, Sol l 3, Sol l 4), black fire ant (Sol r 2, Sol r 3), Brazilian fire ant (Sol s 2, Sol s 3), horsefly (Tab y 1, Tab y 2, Tab y 5), pine processionary moth (Tha p 1, Tha p 2), California kissing bug (Tria p 1), European hornet (Vesp c 1, Vesp c 5), Vespa magnifca (hornet) (Vesp ma 2, Vesp ma 5), Vespa mandarinia (Giant asian hornet) (Vesp ml, Vesp m 5), yellow jacket (Ves f 5, Ves g 5, Ves m 1, Ves m 2, Ves m 5), Vespula germanica (yellow jacket) (Ves p 5), Vespula squamoso (Yellow jacket) (Ves s 1, Ves s5), Vespula vulgaris (Yellow jacket) (Ves v 1, Ves v 2, Ves v 3, Ves v 4, Ves v 5, Ves v 6), Blottella germanica (Bla g 1.0101, Bla g 1.0102, Bla g 1.0103, Bla g 1.02, Bla g 6.0101, Bla g 6.0201, Bla g 6.0301), Periplaneta Americana (Per a1.0101, Per a1.0102, Per a1.0103, Per a1.0104, Per a1.02, Per a3.01, Per a3.0201, Per a3.0202, Per a3.0203, Per a7.0101, Per a7.0102), Vespa crabo (Ves pc 5.0101, Ves pc 5.0101), Vespa mandarina (Vesp m 1.01, Vesp m 1.02); and any variants thereof.

Examples of allergenic proteins from fungi/mold that can be detected using the systems and processes of the present disclosure include, but are not limited to, Alternaria alternata (Alternaria rot fungus) (Alt a 1, Alt a 3, Alt a 4, Alt a 5, Alt a 6, Alt a 7, Alt a 8, Alt a 10, Alt a 12, Alt a 13), Aspergillus flavus (fungus) (Asp fl 13), Aspergillus fumigatus (fungus) (Asp f 1, Asp f 2, Asp f 3, Asp f 4, Asp f 5, Asp f 6, Asp f 7, Asp f 8, Asp f 9, Asp f 10, Asp f 11, Asp f 12, Asp f 13, Asp f 15, Asp f 16, Asp f 17, Asp f 18, Asp f 22, Asp f 23, Asp f 27, Asp f 28, Asp f 29, Asp f 34), Aspergillus niger (Asp n 14, Asp n 18, Asp n 25), Aspergillus oryzae (Asp o 13, Asp o 21), Aspergillus versicolor (Asp v 13), Candida albicans (Yeast) (Cand a 1, Cand a 3), Candida boidinii (Yeast) (Cand b 2), Cladosporium cladosporioides (Cla c 9, Cla c 14), Cladosporium herborum (Cla h 2, Cla h 5, Cla h 6, Cla h 7, Cla h 8, Cla h 9, Cla h 10, Cla h 12), Curvularia lunata (Synonym: Cochliobolus lunatus) (Cur l 1, Cur l 2, Cur l 3, Cur l 4), Epicoccum purpurascens (Soil fungus) (Epi p 1), Fusarium culmorum (N.A.) (Fus c 1, Fus c 2), Fusarium proliferatum (Fus p 4), Penicillium brevicompactum (Pen b 13, Pen b 26), Penicillium chrysogenum (Pen ch 13, Pen ch 18, Pen ch 20, Pen ch 31, Pen ch 33, Pen ch 35), Penicillium citrinum (Pen c 3, Pen c 13, Pen c 19, Pen c 22, Pen c 24, Pen c 30, Pen c 32), Penicillium crustosum (Pen cr 26), Penicillium oxalicum (Pen o 18), Stachybotrys chartorum (Sta c 3), Trichophyton rubrum (Tri r 2, Tr r 4), Trichophyton tonsurans (Tri t 1, Tri t 4), Psilocybe cubensis (Psi c 1, Psi c 2), Shaggy cap (Cop c 1, Cop c 2, Cop c 3, Cop c 5, Cop c 7), Rhodotorula muciloginosa (Rho m 1, Rho m 2), Malassezia furfur (Malaf2, Malaf3, Malaf4), Malassezia sympodialis (Malas1, Malas5, Malas6, Malas7, Malas8, Malas9, Malas10, Malas11, Malas12, Malas13) and Alternaria alternate (Alt a1.0101, Alt a1.0102); and any variants thereof.

Examples of additional allergens include, but are not limited to, Nematode (Ani s 1, Ani s 2, Ani s 3, Ani s 4), worm (Asc s 1), soft coral (Den n 1), rubber (Latex) (Hey b 1, Hey b 2, Hey b 3, Hey b 5, Hey b 6, Hey b 7, Hey b 8, Hey b 9, Hey b 10, Hey b 11, Hey b 12, Hey b 13), obeche (Trip s 1) and Heveabrasiliensis (Hey b6.01, Hey b6.0201, Hey b6.0202, Hey b6.03, Hey b8.0101, Hey b8.0102, Hey b8.0201, Hey b8.0202, Hey b8.0203, Hey b8.0204, Hey b10.0101, Hey b10.0102, Hey b10.0103, Hey b11.0101, Hey b11.0102); and any variants thereof.

The nanofibrous material may be prepared by any appropriate method as known to those skilled in the art, but typically is prepared by electrospinning. In electrospinning, a high voltage (e.g., about 3 to about 50 kV) is applied between a target (or collector) and a conducting capillary into which a polymer solution or melt is injected. The high voltage can also be applied to the solution or melt through a wire if the capillary is a nonconductor such as a glass pipette. The collector may be a metal plate or screen, a rotating drum, or even a liquid bath if the capillary is vertical. Initially the solution at the open tip of the capillary is pulled into a conical shape (the so-called “Taylor cone”) through the interplay of electrical force and surface tension. At a certain voltage range, a fine jet of polymer solution (or melt) forms at the tip of the Taylor cone and shoots toward the target. Forces from the electric field accelerate and stretch the jet. This stretching, together with evaporation of solvent molecules, causes the jet diameter to become smaller. As the jet diameter decreases, the charge density increases until electrostatic forces within the polymer overcome the cohesive forces holding the jet together (e.g., surface tension), causing the jet to split or “splay” into a multifilament of polymer fibers. The fibers continue to splay until they reach the collector, where they are collected as nonwoven fibers, and are optionally dried. The diameter of an electrospun nanofiber is typically between about 50 nm and about 5 μm. In some embodiments, the nanofibrous material comprises polyvinylpyrrolidone (PVP). However, any other suitable polymer, in particular polymers that are water soluble and show good biocompatibility, may be used, for example but not limited to polyvinyl alcohol (PVA), polyethylene glycol (PEG), or polypropylene glycol (PPG).

In some aspects, the sensor of the present disclosure comprises an antibody with specificity for the allergen. As used herein, the term “antibody” is used in the broadest sense and specifically covers various embodiments including, but not limited to monoclonal antibodies, polyclonal antibodies, multispecific antibodies (e.g. bispecific antibodies formed from at least two intact antibodies), and antibody fragments such as diabodies so long as they exhibit a desired biological activity. Antibodies are primarily amino-acid based molecules but may also comprise one or more modifications such as with sugar moieties.

“Antibody fragments” comprise a portion of an intact antibody, preferably comprising an antigen binding region thereof. Examples of antibody fragments include Fab, Fab′, F(ab′)2, and Fv fragments; diabodies; linear antibodies; single-chain antibody molecules; and multispecific antibodies formed from antibody fragments. Papain digestion of antibodies produces two identical antigen-binding fragments, called “Fab” fragments, each with a single antigen-binding site. Also produced is a residual “Fc” fragment, whose name reflects its ability to crystallize readily. Pepsin treatment yields an F(ab′)2 fragment that has two antigen-binding sites and is still capable of cross-linking antigen. For the purposes herein, an “antibody” may comprise a heavy and light variable domain as well as an Fc region.

“Native antibodies” are usually heterotetrameric glycoproteins of about 150,000 Daltons, composed of two identical light (L) chains and two identical heavy (H) chains. Each light chain is linked to a heavy chain by one covalent disulfide bond, while the number of disulfide linkages varies among the heavy chains of different immunoglobulin isotypes. Each heavy and light chain also has regularly spaced intrachain disulfide bridges. Each heavy chain has at one end a variable domain (VH) followed by a number of constant domains. Each light chain has a variable domain at one end (VL) and a constant domain at its other end; the constant domain of the light chain is aligned with the first constant domain of the heavy chain, and the light chain variable domain is aligned with the variable domain of the heavy chain.

As used herein, the term “variable domain” refers to specific antibody domains that differ extensively in sequence among antibodies and are used in the binding and specificity of each particular antibody for its particular antigen. As used herein, the term “Fv” refers to antibody fragments which contain a complete antigen-recognition and antigen-binding site. This region consists of a dimer of one heavy chain and one light chain variable domain in tight, non-covalent association.

Antibody “light chains” from any vertebrate species can be assigned to one of two clearly distinct types, called kappa and lambda based on amino acid sequences of their constant domains. Depending on the amino acid sequence of the constant domain of their heavy chains, antibodies can be assigned to different classes. There are five major classes of intact antibodies: IgA, IgD, IgE, IgG, and IgM, and several of these may be further divided into subclasses (isotypes), e.g., IgG1, IgG2, IgG3, IgG4, IgA, and IgA2.

“Single-chain Fv” or “scFv,” as used herein, refers to a fusion protein of VH and VL antibody domains, wherein these domains are linked together into a single polypeptide chain. In some embodiments, the Fv polypeptide linker enables the scFv to form the desired structure for antigen binding.

The term “diabodies” refers to small antibody fragments with two antigen-binding sites, which fragments comprise a heavy chain variable domain VH connected to a light chain variable domain VL in the same polypeptide chain. By using a linker that is too short to allow pairing between the two domains on the same chain, the domains are forced to pair with the complementary domains of another chain and create two antigen-binding sites. Diabodies are described more fully in, for example, EP 404,097; WO 93/11161; and Hollinger et al., Proc. Natl. Acad. Sci. USA, 90:6444-6448 (1993), the contents of each of which are incorporated herein by reference in their entirety.

The term “monoclonal antibody” as used herein refers to an antibody obtained from a population of substantially homogeneous cells (or clones), i.e., the individual antibodies comprising the population are identical and/or bind the same epitope, except for possible variants that may arise during production of the monoclonal antibody, such variants generally being present in minor amounts. In contrast to polyclonal antibody preparations that typically include different antibodies directed against different determinants (epitopes), each monoclonal antibody is directed against a single determinant on the antigen.

The modifier “monoclonal” indicates the character of the antibody as being obtained from a substantially homogeneous population of antibodies, and is not to be construed as requiring production of the antibody by any particular method. The monoclonal antibodies herein include “chimeric” antibodies (immunoglobulins) in which a portion of the heavy and/or light chain is identical with or homologous to corresponding sequences in antibodies derived from a particular species or belonging to a particular antibody class or subclass, while the remainder of the chain(s) is identical with or homologous to corresponding sequences in antibodies derived from another species or belonging to another antibody class or subclass, as well as fragments of such antibodies.

“Humanized” forms of non-human (e.g., murine) antibodies are chimeric antibodies that contain minimal sequence derived from non-human immunoglobulin. For the most part, humanized antibodies are human immunoglobulins (recipient antibody) in which residues from the hypervariable region from an antibody of the recipient are replaced by residues from the hypervariable region from an antibody of a non-human species (donor antibody) such as mouse, rat, rabbit or nonhuman primate having the desired specificity, affinity, and capacity.

The term “hypervariable region” when used herein in reference to antibodies refers to regions within the antigen binding domain of an antibody comprising the amino acid residues that are responsible for antigen binding. The amino acids present within the hypervariable regions determine the structure of the complementarity determining region (CDR). As used herein, the “CDR” refers to the region of an antibody that comprises a structure that is complimentary to its target antigen or epitope.

In some embodiments, the compositions of the present disclosure may be antibody mimetics. The term “antibody mimetic” refers to any molecule which mimics the function or effect of an antibody and which binds specifically and with high affinity to their molecular targets. As such, antibody mimics include nanobodies and the like.

In some embodiments, antibody mimetics may be those known in the art including, but are not limited to affibody molecules, affilins, affitins, anticalins, avimers, DARPins, Fynomers and Kunitz and domain peptides. In other embodiments, antibody mimetics may include one or more non-peptide region.

As used herein, the term “antibody variant” refers to a biomolecule resembling an antibody in structure and/or function comprising some differences in their amino acid sequence, composition or structure as compared to a native antibody.

The preparation of antibodies, whether monoclonal or polyclonal, is known in the art. Techniques for the production of antibodies are well known in the art and described, e.g. in Harlow and Lane “Antibodies, A Laboratory Manual”, Cold Spring Harbor Laboratory Press, 1988 and Harlow and Lane “Using Antibodies: A Laboratory Manual” Cold Spring Harbor Laboratory Press, 1999.

In one embodiment, antibodies, antibody fragments, their variants or derivatives as described above are specifically immunoreactive with allergens. Antibodies or fragments of antibodies may also bind to target sites on allergens.

Antibodies of the present disclosure may be characterized by their target molecule(s), by the antigens used to generate them, by their function (whether as agonists or antagonists) and/or by the cell niche in which they function.

Measures of antibody function may be made relative to a standard under normal physiologic conditions, in vitro or in vivo. Measurements may also be made relative to the presence or absence of the antibodies. Such methods of measuring include standard measurement in tissue or fluids such as serum or blood such as Western blot, enzyme-linked immunosorbent assay (ELISA), activity assays, reporter assays, luciferase assays, polymerase chain reaction (PCR) arrays, gene arrays, real time reverse transcriptase (RT) PCR and the like.

Antibodies may bind or interact with any number of locations on or along an allergen protein. Allergen antibody target sites contemplated include any and all possible sites for detecting said allergen.

Antibodies of the present disclosure exert their effects via binding (reversibly or irreversibly) to one or more allergen target sites. While not wishing to be bound by any one theory, target sites which represent a binding site for an antibody are most often formed by proteins or protein domains or regions. However, target sites may also include biomolecules such as sugars, lipids, nucleic acid molecules or any other form of binding epitope.

Antibodies of the present disclosure, as well as antigens used to generate them, are primarily amino acid-based molecules. These molecules may be “peptides,” “polypeptides,” or “proteins.”

As used herein, the term “peptide” refers to an amino-acid based molecule having from 2 to 50 or more amino acids. Special designators apply to the smaller peptides with “dipeptide” referring to a two amino acid molecule and “tripeptide” referring to a three amino acid molecule. Amino acid based molecules having more than 50 contiguous amino acids are considered polypeptides or proteins.

The terms “amino acid” and “amino acids” refer to all naturally occurring L-alpha-amino acids as well as non-naturally occurring amino acids. Amino acids are identified by either the one-letter or three-letter designations as follows: aspartic acid (Asp: D), isoleucine (lie: 1), threonine (Thr: T), leucine (Leu: L), serine (Ser: S), tyrosine (Tyr: Y), glutamic acid (Glu: E), phenylalanine (Phe: F), proline (Pro: P), histidine (His: H), glycine (Gly: G), lysine (Lys: K), alanine (Ala: A), arginine (Arg: R), cysteine (Cys: C), tryptophan (Trp: W), valine (Val: V), glutamine (Gln: Q) methionine (Met: M), and asparagine (Asn: N), where the amino acid is listed first followed parenthetically by the three and one letter codes, respectively.

Antibodies of the present disclosure may be polyclonal or monoclonal or recombinant, produced by methods known in the art or as described in this application.

In some embodiments, the antibodies of the present disclosure may be labeled for purposes of detection with a detectable label known by one of skill in the art. The label can be a radioisotope, fluorescent compound, chemiluminescent compound, enzyme, or enzyme co-factor, or any other labels known in the art. In some aspects, the antibody that binds to a desired antigen is not labeled, but may be detected by binding of a labeled secondary antibody that specifically binds to the primary antibody.

Antibodies of the present disclosure include, but are not limited to, polyclonal, monoclonal, multispecific, human, humanized or chimeric antibodies, single chain antibodies, Fab fragments, F(ab′) fragments, fragments produced by a Fab expression library, anti-idiotypic (anti-Id) antibodies (including, e.g., anti-Id antibodies to antibodies of the disclosure), intracellularly made antibodies (i.e., intrabodies), and epitope-binding fragments of any of the above. Antibodies of the present disclosure can be from any animal origin including birds and mammals. Preferably, such antibodies are of human, murine (e.g., mouse and rat), donkey, sheep, rabbit, goat, guinea pig, camel, horse, or chicken origin. The antibodies of the present disclosure can be monospecific or multispecific (e.g., bispecific, trispecific, or of greater multispecificity). Multispecific antibodies can be specific for different epitopes of a peptide of the present disclosure, or can be specific for both a peptide of the present disclosure, and a heterologous epitope, such as a heterologous peptide or solid support material. (See, e.g., WO 93/17715; WO 92/08802; WO 91/00360; WO 92/05793; Tutt, A. et al., Trispecific F(ab)3 derivatives that use cooperative signaling via the TCR/CD3 complex and CD2 to activate and redirect resting cytotoxic T cells. J Immunol. 1991 Jul. 1; 147(1):60-9; U.S. Pat. Nos. 4,474,893; 4,714,681; 4,925,648; 5,573,920; 5,601,819; and Kostelny, S. A. et al., Formation of a bispecific antibody by the use of leucine zippers. J Immunol. 1992 Mar. 1; 148(5):1547-53). For example, the antibodies may be produced against a peptide containing repeated units of a peptide sequence of the present disclosure, or they may be produced against a peptide containing two or more peptide sequences of the present disclosure, or the combination thereof.

As a non-limiting example, a heterobivalent ligand (HBL) system that competitively inhibits allergen binding to mast cell bound IgE antibody, thereby inhibiting mast cell degranulation, has been designed (Handlogten, et al., Design of a Heterobivalent Ligand to Inhibit IgE Clustering on Most Cells, Chemistry & Biology, 2011 Sep. 23, 18(9):1179-1188).

In some embodiments, antibodies can be prepared from any region of an allergen. In the present disclosure, the peptides for generating antibodies preferably contain a sequence of at least 4, at least 5, at least 6, at least 7, more preferably at least 8, at least 9, at least 10, at least 11, at least 12, at least 13, at least 14, at least 15, and, preferably, between about 5 to about 50 amino acids in length, more preferably between about 10 to about 30 amino acids in length, even more preferably between about 10 to about 20 amino acids in length.

In certain embodiments of the present disclosure, where larger polypeptides or proteins are used for generating antibodies, these preferably are at least 50, at least 55, at least 60, at least 70, at least 80, at least 90, or more amino acids in length.

Monoclonal antibodies of the present disclosure can be prepared using well-established methods known by those skilled in the art. In one embodiment, the monoclonal antibodies are prepared using hybridoma technology (Kohler, G. et al., Continuous cultures of fused cells secreting antibody of predefined specificity. Nature. 1975 Aug. 7: 256 (5517): 495-7). In a hybridoma method, a mouse, hamster, or other appropriate host animal, is typically immunized with an immunizing agent (e.g., a peptide of the disclosure) to elicit lymphocytes that produce or are capable of producing antibodies that will specifically bind to the immunizing agent. Alternatively, the lymphocytes may be immunized in vitro. The lymphocytes are then fused with an immortalized cell line using a suitable fusing agent, such as polyethylene glycol, to form a hybridoma cell (Goding, J. W., Monoclonal Antibodies: Principles and Practice. Academic Press. 1986; 59-1031). Immortalized cell lines are usually transformed mammalian cells, particularly myeloma cells of rodent, rabbit, bovine and human origin. Usually, rat or mouse myeloma cell lines are employed. The hybridoma cells may be cultured in a suitable culture medium that preferably contains one or more substances that inhibit the growth or survival of the unfused, immortalized cells. For example, if the parental cells lack the enzyme hypoxanthine guanine phosphoribosyl transferase (HGPRT or HPRT), the culture medium for the hybridomas typically will include hypoxanthine, aminopterin, and thymidine (“HAT medium”), which substances prevent the growth of HGPRT-deficient cells.

Preferred immortalized cell lines are those that fuse efficiently, support stable high level expression of antibody by the selected antibody-producing cells, and are sensitive to a medium such as HAT medium. More preferred immortalized cell lines are murine myeloma lines, which can be obtained, for instance, from the Salk Institute Cell Distribution Center, San Diego, Calif. and the American Type Culture Collection, Manassas, Va. Human myeloma and mouse-human heteromyeloma cell lines also have been described for the production of human monoclonal antibodies (Kozbor, D. et al., A human hybrid myelomo for production of human monoclonal antibodies. J Immunol. 1984 December; 133(6): 3001-5; Brodeur, B. et al., Monoclonal Antibody Production Techniques and Applications. Marcel Dekker, Inc., New York. 1987; 33:51-63).

The culture medium in which the hybridoma cells are cultured can then be assayed for the presence of monoclonal antibodies. Preferably, the binding specificity (i.e., specific immunoreactivity) of monoclonal antibodies produced by the hybridoma cells is determined by immunoprecipitation or by an in vitro binding assay, such as radioimmunoassay (MA) or enzyme-linked immunosorbent assay (ELISA). Such techniques and assays are known by those skilled in the art. The binding specificity of the monoclonal antibody can, for example, be determined by Scatchard analysis (Munson, P. J. et al., Ligand: a versatile computerized approach for characterization of ligand-binding systems. Anal Biochem. 1980 Sep. 1; 107(1):220-39).

After the desired hybridoma cells are identified, the clones may be subcloned by limiting dilution procedures and grown by standard methods. Suitable culture media for this purpose include, for example, Dulbecco's Modified Eagle's Medium or RPMI-1640 medium. Alternatively, the hybridoma cells may be grown in vivo as ascites in a mammal.

The monoclonal antibodies secreted by the subclones may be isolated or purified from the culture medium or ascites fluid by conventional immunoglobulin purification procedures such as, for example, protein A-Sepharose, hydroxylapatite chromatography, gel electrophoresis, dialysis, or affinity chromatography.

In another embodiment, the monoclonal antibodies of the present disclosure can also be made by recombinant DNA methods, such as those described in U.S. Pat. No. 4,816,567, which is hereby incorporated by reference in its entirety. DNA encoding the monoclonal antibodies of the disclosure can be readily isolated and sequenced using conventional procedures (e.g., by using oligonucleotide probes that are capable of binding specifically to genes encoding the heavy and light chains of murine antibodies). The hybridoma cells of the disclosure serve as a preferred source of DNA. Once isolated, the DNA can be placed into expression vectors, which are then transfected into host cells such as simian COS cells, Chinese hamster ovary (CHO) cells, or myeloma cells that do not otherwise produce immunoglobulin protein, to obtain the synthesis of monoclonal antibodies in the recombinant host cells. The DNA also can be modified, for example, by substituting the coding sequence for human heavy and light chain constant domains in place of the homologous murine sequences (U.S. Pat. No. 4,816,567) or by covalently joining to the immunoglobulin coding sequence all or part of the coding sequence for a non-immunoglobulin polypeptide. Such a non-immunoglobulin polypeptide can be substituted for the constant domains of an antibody of the disclosure, or can be substituted for the variable domains of one antigen-combining site of an antibody of the disclosure to create a chimeric bivalent antibody.

In another embodiment, antibodies of the present disclosure can also be produced by various procedures known by those skilled in the art. For the production of polyclonal antibodies in vivo, host animals, such as rabbits, rats, mice, sheep, or goats, are immunized with either free or carrier-coupled peptides, for example, by intraperitoneal and/or intradermal injection. Injection material is typically an emulsion containing about 100 μg of peptide or carrier protein. Various adjuvants can also be used to increase the immunological response, depending on the host species. Adjuvants include, but are not limited to, Freund's (complete and incomplete), mineral gels such as aluminum hydroxide, surface active substances such as lysolecithin, pluronic polyols, polyanions, peptides, oil emulsions, keyhole limpet hemocyanins, dinitrophenol, and other useful human adjuvants such as BCG (Bacillus Calmette-Guerin) and Corynebacterium parvum. Such adjuvants are also well known in the art. Several booster injections may be needed, for instance, at intervals of about two weeks, to provide a useful titer of antibody which can be detected, for example, by ELISA assay using free peptide adsorbed to a solid surface. The titer of antibodies in serum from an immunized animal can be increased by selection of antibodies, e.g., by adsorption of the peptide onto a solid support and elution of the selected antibodies according to methods well known in the art.

Antibodies, variants and fragments thereof may be selected and produced using high throughput methods of discovery. In one embodiment, synthetic antibodies, variants and fragments thereof are produced through the use of display libraries. The term “display” as used herein, refers to the expression or “display” of proteins or peptides on the surface of a given host. The term “library” as used herein, refers to a collection of unique cDNA sequences. A library may contain from as little as two unique cDNAs to hundreds of billions of unique cDNAs. In a preferred embodiment, Synthetic antibodies are produced using antibody display libraries or antibody fragment display libraries. The term “antibody fragment display library” as used herein, refers to a display library wherein each member encodes an antibody fragment containing at least one variable region of an antibody. Such antibody fragments are preferably Fab fragments, but other antibody fragments such as single-chain variable fragments (scFvs) are contemplated as well. In an Fab antibody fragment library, each Fab encoded may be identical except for the amino acid sequence contained within the variable loops of the complementarity determining regions (CDRs) of the Fab fragment. In an alternative or additional embodiment, amino acid sequences within the individual VH and/or VL regions may differ as well.

Display libraries may be expressed in a number of possible hosts including, but not limited to yeast, bacteriophage, bacteria and retroviruses. Additional display technologies that may be used include ribosome-display, microbead-display and protein-DNA linkage techniques. In a preferred embodiment, Fab display libraries are expressed in yeast or in bacteriophages (also referred to herein as “phages” or “phage particles.” When expressed, the Fabs decorate the surface of the phage or yeast where they can interact with a given antigen. An antigen comprising an allergen or an antigen from a desired target site may be used to select phage particles or yeast cells expressing antibody fragments with the highest affinity for that antigen. The DNA sequence encoding the CDR of the bound antibody fragment can then be determined through sequencing using the bound particle or cell. In one embodiment, positive selection is used in the development of antibodies. As used herein, the term “positive selection” refers to processes by which antibodies and/or fragments thereof are selected from display libraries based on affinity for antigens containing target sites. In some embodiments, negative selection is utilized in the development of antibodies. As used herein, the term “negative selection” refers to processes by which antigens that lack target sites for antibody production are used to exclude antibodies and/or fragments thereof from a given display library during antibody development. In some embodiments, both positive and negative selection processes are utilized during multiple rounds of selection in the development of antibodies using display libraries.

In yeast display, cDNA encoding different antibody fragments are introduced into yeast cells where they are expressed and the antibody fragments are “displayed” on the cell surface as described by Chao et al. (Chao, G. et al., Isolating and engineering human antibodies using yeast surface display. Nat Protoc. 2006; 1(2):755-68). In yeast surface display, expressed antibody fragments contain an additional domain comprising the yeast agglutinin protein, Aga2p. This domain allows the antibody fragment fusion protein to attach to the outer surface of the yeast cell through the formation of disulfide bonds with surface-expressed Aga1p. The result is a yeast cell, coated in a particular antibody fragment. Display libraries of cDNA encoding these antibody fragments are utilized initially in which the antibody fragments each have a unique sequence. These fusion proteins are expressed on the cell surface of millions of yeast cells where they can interact with a desired antigenic target peptide, incubated with the cells. Target peptides may be covalently or otherwise modified with a chemical or magnetic group to allow for efficient cell sorting after successful binding with a suitable antibody fragment takes place. Recovery may be by way of magnetic-activated cell sorting (MACS), fluorescence-activated cell sorting (FACS) or other cell sorting methods known in the art. Once a subpopulation of yeast cells is selected, the corresponding plasmids may be analyzed to determine the CDR sequence.

Bacteriophage display methods typically utilize filamentous phage including fd, F1 and M13 virions. Such strains are non-lytic, allowing for continued propagation of the host and increased viral titres. Examples of phage display methods that can be used to make the antibodies of the present disclosure include those disclosed in Miersch et al. (Miersch, S. et al., Synthetic antibodies: Concepts, potential and practical considerations. Methods. 2012 August; 57(4): 486-98), Bradbury et al. (Bradbury, A. R. et al., Beyond natural antibodies: the power of in vitro display technologies. Nat Biotechnol. 2011 March; 29(3):245-54), Brinkman et al. (Brinkmann, U. et al., Phage display of disulfide-stabilized Fv fragments. J Immunol Methods. 1995 May 11; 182(1):41-50); Ames et al. (Ames, R. S. et al., Conversion of murine Fobs isolated from a combinatorial phage display library to full length immunoglobulins. J Immunol Methods. 1995 Aug. 18; 184(2):177-86); Kettleborough et al. (Kettleborough, C. A. et al., Isolation of tumor cell-specific single-chain Fv from immunized mice using phage-antibody libraries and the re-construction of whole antibodies from these antibody fragments. Eur J Immunol. 1994 April; 24(4):952-8); Persic et al. (Persic, L et al., An integrated vector system for the eukaryotic expression of antibodies or their fragments ofter selection from phage display libraries. Gene. 1997 Mar. 10; 187(1):9-18); PCT application No. PCT/GB91/01134; PCT publications WO 90/02809; WO 91/10737; WO 92/01047; WO 92/18619; WO 93/11236; WO 95/15982; WO 95/20401; and U.S. Pat. Nos. 5,698,426; 5,223,409; 5,403,484; 5,580,717; 5,427,908; 5,750,753; 5,821,047; 5,571,698; 5,427,908; 5,516,637; 5,780,225; 5,658,727; 5,733,743 and 5, 969,108, each of which is incorporated herein by reference in its entirety.

Antibody fragment expression on bacteriophages may be carried out by inserting the cDNA encoding the fragment into the gene expressing a viral coat protein. The viral coat of filamentous bacteriophages is made up of five coat proteins, encoded by a single-stranded genome. Coat protein pill is the preferred protein for antibody fragment expression, typically at the N-terminus. If antibody fragment expression compromises the function of pill, viral function may be restored through coexpression of a wild type pill, although such expression will reduce the number of antibody fragments expressed on the viral coat, but may enhance access to the antibody fragment by the target antigen. Expression of viral as well as antibody fragment proteins may alternatively be encoded on multiple plasmids. This method may be used to reduce the overall size of infective plasmids and enhance the transformation efficiency.

As described above, after selection of a host expressing a high affinity antibody or antibody fragment, the coding regions from the antibody or antibody fragment can be isolated and used to generate whole antibodies, including human antibodies, or any other desired antigen binding fragment, and expressed in any desired host, including mammalian cells, insect cells, plant cells, yeast, and bacteria, e.g., as described in detail below.

The DNA sequence encoding a high affinity antibody can be mutated for additional rounds of selection in a process known as affinity maturation. The term “affinity maturation,” as used herein, refers to a method whereby antibodies are produced with increasing affinity for a given antigen through successive rounds of mutation and selection of antibody- or antibody fragment-encoding cDNA sequences. In a preferred embodiment, this process is carried out in vitro. To accomplish this, amplification of CDR coding sequences may be carried out using error-prone PCR to produce millions of copies containing mutations including, but not limited to point mutations, regional mutations, insertional mutations and deletional mutations. As used herein, the term “point mutation” refers to a nucleic acid mutation in which one nucleotide within a nucleotide sequence is changed to a different nucleotide. As used herein, the term “regional mutation” refers to a nucleic acid mutation in which two or more consecutive nucleotides are changed to different nucleotides. As used herein, the term “insertional mutation” refers to a nucleic acid mutation in which one or more nucleotides are inserted into a nucleotide sequence. As used herein, the term “deletional mutation” refers to a nucleic acid mutation in which one or more nucleotides are removed from a nucleotide sequence. Insertional or deletional mutations may include the complete replacement of an entire codon or the change of one codon to another by altering one or two nucleotides of the starting codon.

Mutagenesis may be carried out on CDR-encoding cDNA sequences to create millions of mutants with singular mutations in CDR heavy and light chain regions. In another approach, random mutations are introduced only at CDR residues most likely to improve affinity. These newly generated mutagenic libraries can be used to repeat the process to screen for clones that encode antibody fragments with even higher affinity for the target peptide. Continued rounds of mutation and selection promote the synthesis of clones with greater and greater affinity (Chao, G. et al., Isolating and engineering human antibodies using yeast surface display. Nat. Protoc. 2006; 1(2):755-68).

Examples of techniques that can be used to produce antibodies and antibody fragments, such as Fabs and scFvs, include those described in U.S. Pat. Nos. 4,946,778 and 5,258,498; Miersch et al. (Miersch, S. et al., Synthetic antibodies: Concepts, potential and practical considerations. Methods. 2012 August; 57(4):486-98), Chao et al. (Chao, G. et al., Isolating and engineering human antibodies using yeast surface display. Nat Protoc. 2006; 1(2):755-68), Huston et al. (Huston, J. S. et al., Protein engineering of single-chain Fv analogs and fusion proteins. Methods Enzymol. 1991; 203:46-88); Shu et al. (Shu, L et al., Secretion of a single-gene-encoded immunoglobulin from myeloma cells. Proc. Natl. Acad. Sci. U.S.A 1993 Sep. 1; 90(17):7995-9); and Skerra et al. (Skerra, A. et al., Assembly of a functional immunoglobulin Fv fragment in Escherichia coli. Science. 1988 May 20; 240(4855):1038-41), each of which is incorporated herein by reference in its entirety.

For some uses, including the in vivo use of antibodies in humans and in vitro detection assays, it may be preferable to use chimeric, humanized, or human antibodies. A chimeric antibody is a molecule in which different portions of the antibody are derived from different animal species, such as antibodies having a variable region derived from a murine monoclonal immunoglobulin and a human immunoglobulin constant region. Methods for producing chimeric antibodies are known in the art. (Morrison, S. L, Transfectomas provide novel chimeric antibodies. Science. 1985 Sep. 20; 229(4719):1202-7; Gillies, S. D. et al., High-level expression of chimeric antibodies using adapted cDNA variable region cassettes. J Immunol Methods. 1989 Dec. 20; 125(1-2):191-202; and U.S. Pat. Nos. 5,807,715; 4,816,567; and 4,816,397, which are incorporated herein by reference in their entirety).

Humanized antibodies are antibody molecules from non-human species that bind to the desired antigen and have one or more complementarity determining regions (CDRs) from the nonhuman species and framework regions from a human immunoglobulin molecule. Often, framework residues in the human framework regions are substituted with corresponding residues from the CDR and framework regions of the donor antibody to alter, preferably improve, antigen binding. These framework substitutions are identified by methods well known in the art, e.g., by modeling of the interactions of the CDR and framework residues to identify framework residues important for antigen binding, and by sequence comparison to identify unusual framework residues at particular positions. (U.S. Pat. Nos. 5,693,762 and 5,585,089; Riechmann, L. et al., Reshaping human antibodies for therapy. Nature. 1988 Mar. 24; 332(6162):323-7, which are incorporated herein by reference in their entireties).

Antibodies can be humanized using a variety of techniques known in the art, including, for example, CDR-grafting (EP 239,400; PCT publication WO 91/09967; U.S. Pat. Nos. 5,225,539; 5,530,101; and 5,585,089); veneering or resurfacing (EP 592,106; EP 519,596; Padlan, E. A., A possible procedure for reducing the immunogenicity of antibody variable domains while preserving their ligand-binding properties. Mol Immunol. 1991 April-May; 28(4-5):489-98; Studnicka, G. M. et al., Human-engineered monoclonal antibodies retain full specific binding activity by preserving non-CDR complementarity-modulating residues. Protein Eng. 1994 June; 7(6):805-14; Roguska, M. A. et al., Humanization of murine monoclonal antibodies through variable domain resurfacing. Proc. Natl. Acad. Sci. U.S.A 1994 Feb. 1; 91(3):969-73); and chain shuffling (U.S. Pat. No. 5,565,332); each of which is incorporated herein by reference in their entirety.

Human antibodies can be made by a variety of methods known in the art, including the antibody display methods described above, using antibody libraries derived from human immunoglobulin sequences. See also, U.S. Pat. Nos. 4,444,887 and 4,716,111; and PCT publications WO 98/46645, WO 98/50433, WO 98/24893, WO 98/16654, WO 96/34096, WO 96/33735, and WO 91/10741; each of which is incorporated herein by reference in its entirety.

Human antibodies can also be produced using transgenic mice which are incapable of expressing functional endogenous immunoglobulins, but which can express human immunoglobulin polynucleotides. For example, the human heavy and light chain immunoglobulin polynucleotide complexes can be introduced randomly, or by homologous recombination, into mouse embryonic stem cells. Alternatively, the human variable region, constant region, and diversity region may be introduced into mouse embryonic stem cells, in addition to the human heavy and light chain polynucleotides. The mouse heavy and light chain immunoglobulin polynucleotides can be rendered nonfunctional separately or simultaneously with the introduction of human immunoglobulin loci by homologous recombination. In particular, homozygous deletion of the JH region prevents endogenous antibody production. The modified embryonic stem cells are expanded and microinjected into blastocysts to produce chimeric mice. The chimeric mice are then bred to produce homozygous offspring which express human antibodies. The transgenic mice are immunized in the normal fashion with a selected antigen, e.g., all or a portion of a polypeptide of the disclosure.

Thus, using such a technique, it is possible to produce useful human IgG, IgA, IgM, IgD and IgE antibodies. For an overview of the technology for producing human antibodies, see Lonberg and Huszar (Lonberg, N. et al., Human antibodies from transgenic mice. Int. Rev. Immunol. 1995; 13(1):65-93). For a detailed discussion of the technology for producing human antibodies and human monoclonal antibodies and protocols for producing such antibodies, see, e.g., PCT publications WO 98/24893; WO 92/01047; WO 96/34096; WO 96/33735; U.S. Pat. Nos. 5,413,923; 5,625,126; 5,633,425; 5,569,825; 5,661,016; 5,545,806; 5,814,318; 5,885,793; 5,916,771; 5,939,598; 6,075,181; and 6,114,598, each of which are incorporated by reference herein in their entirety. In addition, companies such as Abgenix, Inc. (Fremont, Calif.), Protein Design Labs, Inc. (Mountain View, Calif.) and Genpharm (San Jose, Calif.) can be engaged to provide human antibodies directed against a selected antigen using technology similar to the above described technologies.

Once an antibody molecule of the present disclosure has been produced by an animal, a cell line, chemically synthesized, or recombinantly expressed, it can be purified (i.e., isolated) by any method known in the art for the purification of an immunoglobulin or polypeptide molecule, for example, by chromatography (e.g., ion exchange, affinity, particularly by affinity for the specific antigen, Protein A, and sizing column chromatography), centrifugation, differential solubility, or by any other standard technique for the purification of proteins. In addition, the antibodies of the present disclosure or fragments thereof can be fused to heterologous polypeptide sequences described herein or otherwise known in the art, to facilitate purification.

In some embodiments, the antibody may conjugated to a labeling agent, such as various organic small molecules, inorganic compounds, nanoparticles, enzymes or enzyme substrates, fluorescent materials, luminescent materials (e.g., luminol), bioluminescent materials (e.g., luciferase, luciferin, and aequorin), chemiluminescent materials, radioactive materials (e.g., 18F, 67Ga, 81mKr, 82Rb, 111In, 123I, 133Xe, 201Tl, 125I, 35S, 14C, 3H, or 99mTc (e.g., as pertechnetate (technetate(VII), TcO4)), and contrast agents (e.g., gold (e.g., gold nanoparticles), gadolinium (e.g., chelated Gd), iron oxides (e.g., superparamagnetic iron oxide (SPIO), monocrystalline iron oxide nanoparticles (MIONs), and ultrasmall superparamagnetic iron oxide (USPIO)), manganese chelates (e.g., Mn-DPDP), barium sulfate, iodinated contrast media (iohexol), microbubbles, or perfluorocarbons). Such optically-detectable labels include for example, without limitation, 4-acetamido-4′-isothiocyanatostilbene-2,2′-disulfonic acid; acridine and derivatives (e.g., acridine and acridine isothiocyanate); 5-(2′-aminoethyl)aminonaphthalene-1-sulfonic acid (EDANS); 4-amino-N-[3-vinylsulfonyl)phenyl]naphthalimide-3,5 disulfonate; N-(4-anilino-1-naphthyl)maleimide; anthranilamide; BODIPY; Brilliant Yellow; coumarin and derivatives (e.g., coumarin, 7-amino-4-methylcoumarin (AMC, Coumarin 120), and 7-amino-4-trifluoromethylcoumarin (Coumarin 151)); cyanine dyes; cyanosine; 4′,6-diaminidino-2-phenylindole (DAPI); 5′ 5″-dibromopyrogallol-sulfonaphthalein (bromopyrogallol Red); 7-diethylamino-3-(4′-isothiocyanatophenyl)-4-methylcoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]-naphthalene-1-sulfonyl chloride (DNS, dansylchloride); 4-dimethylaminophenylazophenyl-4′-isothiocyanate (DABITC); eosin and derivatives (e.g., eosin and eosin isothiocyanate); erythrosin and derivatives (e.g., erythrosin B and erythrosin isothiocyanate); ethidium; fluorescein and derivatives (e.g., 5-carboxyfluorescein (FAM), dichlorotriazin-2-yl)aminofluorescein (DTAF), 2′,7′-dimethoxy-4′,5′-dichloro-6-carboxyfluorescein, fluorescein, fluorescein isothiocyanate, X-rhodamine-5-(and-6)-isothiocyanate (QFITC or XRITC), and fluorescamine); 2-[2-[3-[[1,3-dihydro-1,1-dimethyl-3-(3-sulfopropyl)-2H-benz[e]indol-2-ylidene]ethylidene]-2-[4-(ethoxycarbonyl)-1-piperazinyl]-1-cyclopenten-1-yl]ethenyl]-1,1-dimethyl-3-(3-sulfopropyl)-1H-benz[e]indolium hydroxide, inner salt, compound with N,N-diethylethanamine(1:1) (IR144); 5-chloro-2-[2-[3-[(5-chloro-3-ethyl-2(3H)-benzothiazol-ylidene)ethylidene]-2-(diphenylamino)-1-cyclopenten-1-yl]ethenyl]-3-ethyl benzothiazolium perchlorate (IR140); Malachite Green isothiocyanate; 4-methylumbelliferone orthocresolphthalein; nitrotyrosine; pararosaniline; Phenol Red; B-phycoerythrin; o-phthaldialdehyde; pyrene and derivatives (e.g., pyrene, pyrene butyrate, and succinimidyl 1-pyrene); butyrate quantum dots; Reactive Red 4 (CIBACRON™ Brilliant Red 3B-A); rhodamine and derivatives (e.g., 6-carboxy-X-rhodanine (ROX), 6-carboxyrhodamine (R6G), lissamine rhodamine B sulfonyl chloride rhodamine (Rhod), rhodamine B, rhodamine 123, rhodamine X isothiocyanate, sulforhodamine B, sulforhodamine 101, sulfonyl chloride derivative of sulforhodamine 101 (Texas Red), N,N,N′,N′-tetramethyl-6-carboxyrhodamine (TAMRA) tetramethyl rhodamine, and tetramethyl rhodamine isothiocyanate (TRITC)); riboflavin; rosolic acid; terbium chelate derivatives; Cyanine-3 (Cy3); Cyanine-5 (Cy5); cyanine-5.5 (Cy5.5), Cyanine-7 (Cy7); IRD 700; IRD 800; Alexa 647; La Jolta Blue; phthalo cyanine; and naphthalo cyanine. In particular embodiments, the antibody is conjugated to a porphyrin. In some embodiments, the labeling agent may comprise a nanoparticle, a nanotube, or other nanoassembly, for example as described in C. H. Tsai et al. J Microb Biochem Technol 2016, 8:5.

Representative examples of antibodies which may be used in the present disclosure which harbor specificity for one or more allergens include, but are not limited to, 10A4 anti Rat n 1, 10D4 anti Can f 1, 10H4 anti Rat n 1, 1A8 anti Fel d 4, 2H6 anti Rat n 13E4 anti Fel d 1, 5B2 anti Fel d 4, 6E9 anti Can f 1, 6F9 anti Fel d 1, 7E6 anti Can f 1, 10A6 anti Bla g 1, 1F3 anti Bla g 2, 1G9 anti Bla g 5, 2F1 anti Bla g 2, 4B8 anti Bla g 5, 7C11 anti Bla g 2, 10B9 anti Der p 1, 10E11 anti Group 2, 1A6 anti Der p Tropomyosin, 1D8 anti Group 2, 4C1 anti Der p 1/Der f 1, 4D9 anti Blo t 5, 4G9 anti Blo t 5, 5H8 anti Der p 1, 6A8 anti Der f 1, 7A1 anti Group 2, Dpx anti Group 2, 10F2 anti SchX, 2C10 anti Alt a 1, 2C9 ant SchX, 3E11 anti SchX, 3F10 anti SchY, 4A6 anti Asp f 1, 5F5 anti AveX, 9A5 anti AveX, 1D11 anti Phi p 5, 394 anti Bet v 1, 3C7 anti Amb a 1, 5C1 anti Ole e 1, SF6 anti Amb a 1, 5F7 anti Amb a 1, 5G10 anti Cry j 1, 5H8SB anti Bet v 1, 7F11 anti Amb a 1, 8C10 anti Lol p 1, Mouse anti-Der p 2/human IgG1, Mouse anti-Der p2/human IgE, Mouse anti-Der p 2/human IgG4, Rabbit anti-Can f 1, Rabbit anti-Fel d 1, Rabbit anti-Fel d 4, Rabbit anti Guinea Pig Urinary Protein, Rabbit anti Mus m 1, Rabbit anti-Gly d 2, Rabbit anti-Lep d 2, Rabbit anti-Tyr p 2, Rabbit anti-Bla g 1, Rabbit anti-Bla g 2, Rabbit anti-P. americana, Rabbit anti-Asp f 1, Rabbit anti Amb a 1, 11A12 anti Fel d 1 Human IgE, 13B6 anti Can f 1 Human IgE, 188 anti Der p 2 Human IgE, 1e18 anti Fel d 4 Human IgE, 1111 anti Can f 1 Human IgE, 2G1 anti Der p 2 Human IgE, 2111 anti Der p 1 Human IgE, and 6A1 anti Fel d 1 Human IgE.

In typical embodiments of the above sensor, a sample of the allergen is obtained from the environment, for example from settled dust or airborne dust, and is applied to the sensor as an aqueous solution. The aqueous solution is typically formed by bringing up the allergen sample in a buffer, for example, or other biologically compatible aqueous solution which does not lead to significant denaturing of the allergen or antibody contained within the sensor. Suitable buffers or the like would be able to be readily identified by a person of ordinary skill in the art to which this disclosure pertains.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1. Allergen Detecting Badge

A colorimetric badge is designed to identify select allergens (common asthma triggers) in house dust. This includes: cockroach, dust mite (Dermatophagoides pteronyssinus and D. farina), and mouse. The color-changing patches on the lateral flow test are designed using electrospun composites including PVP and antibodies from Indoor Biotechnologies. These antibodies are highly specific and sensitive (L. D. et al., European Journal of Biochemistry, 269, 3086 (2002); and S. M. Pollart, T. F. Smith et al., Journal of Allergy and Clinical Immunology 87, 505 (1991)) and are commonly used in major allergen studies (W. J. Morgan, E. F. Crain et al., New England Journal of Medicine 351, 1068 (2004); O. Olmedo, I. F. Goldstein et al., J Allerg Clin Immuno 128, 284 (2011); C. G. L, C. J. C., P. M. S., Indoor Air 15, 228 (2005); and E. C. Matsui, R. A. Wood et al., Journal of Allergy and Clinical Immunology 112, 87 (2003)), including NHANES (P. M. Salo, J. Wilkerson et al., Journal of Allergy and Clinical Immunology 141, 1870, (2018)). The badge takes several minutes to work, similar to a pregnancy test. For calibration, allergen-spiked standard dust is be mixed into a solution and applied to the color-changing areas on the badge. Each color-changing area will be located next to a nonreactive color calibration patch that can be compared in the app software to calculate the illumination ratio. This ratio will be used to calculate concentration and reported as high, low, or non-detect. Existing thresholds based on literature will be used as they are currently utilized by Indoor Biotechnologies (E. N. Torjusen, G. B. Diette et al., Indoor Air 23, 268 (2013); W. J. Sheehan, W. Phipatanakul, in Pediatric Allergy: Principles and Practice (Third Edition), D. Y. M. Leung, S. J. Szefler, F. A. Bonilla, C. A. Akdis, H. A. Sampson, Eds. (Elsevier, London, 2016), pp. 191; and T. A. Platts-Mills, D. Vervloet et al., Journal of Allergy and Clinical Immunology 100, S2 (1997)).

The badge is designed as a lateral flow test (similar to a pregnancy test). The dust is be collected and directly mixed with a phosphate buffer saline solution with tween for a quick and simple allergen extraction. The wetting area on the badge is then be dipped into the solution. Nitrocellulose fibers connect the wetting area to the color-changing region and a calibration (control) region that also changes color upon delivery of the allergen extract. The system can be tested and evaluated with both vacuumed dust and dust collected on a swab to determine best practices moving forward.

For the color-changing region, nanofibrous biocomposite mats are prepared and used as solid-state biosensors with an optical (visible light) output. This sensor technology is inexpensive, it offers high sensitivity due to the high surface area of the mats, and a long lifetime/use time for the biomolecules (antibodies) that are encapsulated in them (K. Sawicka, P. Gouma, S. Simon, Sensors and Actuators B: Chemical 108, 585 (2005); and K. M. Sawicka, P. Gouma, Journal of Nanoparticle Research 8, 769 (2006)). The process to employ for the synthesis of these mats is High-Throughput Electrospinning (S. Sood, S. Divya, P. Gouma, Journal of Nanoengineering and Nanomanufacturing 4, 39, (2014)) that uses electrostatic forces to draw thin, continuous, fibers from a solution or melt. The procedure to follow for encapsulating antibodies to water soluble polymers is as follows: A precursor solution for electrospinning is prepared using a mixture of polyvinylpyrrolidone (PVP) and distilled water. The solution consists of 0.3 g of PVP per 1 mL of distilled water. After weighing out the PVP, it is slowly added to the water that is magnetically stirred. The precursor is ready when the solution is homogeneous and translucent. Then the antibodies are added to the solution and the final mixture is electrospun.

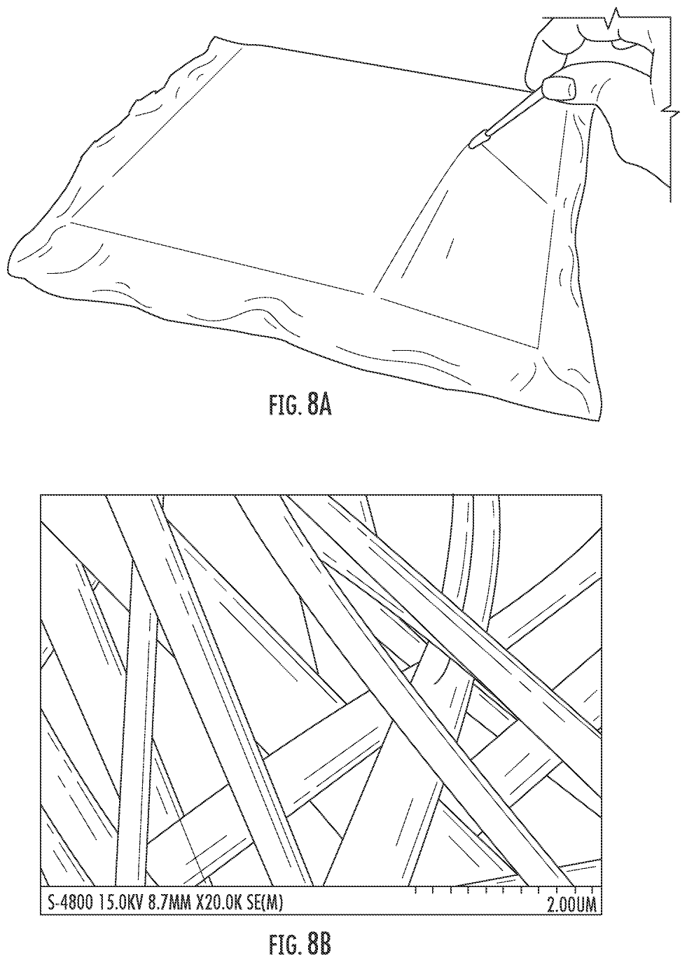

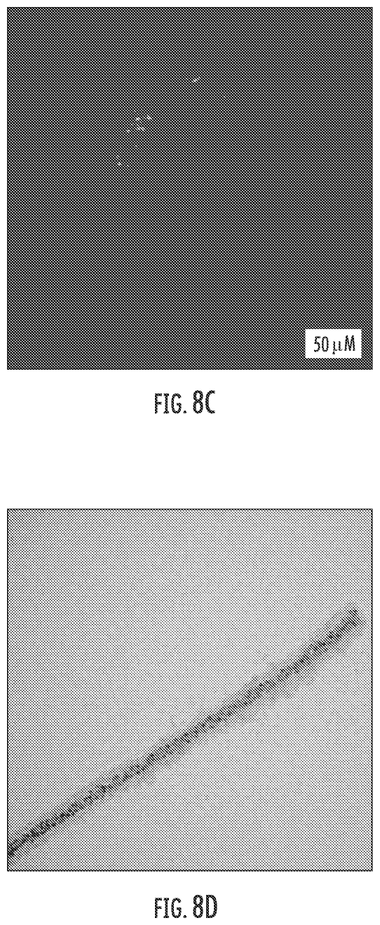

In the present example, an indirect labeling technique was used that allowed confirmation of the encapsulation of the antibodies in the mats during electrospinning (FIGS. 8A-8D). This involved placing 5 μL of secondary antibodies into an Eppendorf tube consisting of 2.5 μL of anti-Mouse IgG secondary antibody with Alexa Fluor 514 and 2.5 μL of anti-Mouse IgG secondary antibody with Alexa Fluor 568. Then, 3.33 μL of each antibody: 10B9 anti-Der p 1, 6A8 anti-Der f 1, and 7C11 anti Bla g 2 were added to the Eppendorf tube containing the secondary antibodies and were incubated at 25° C. for one hour. Post-incubation, the final solution containing 15 μL of primary and secondary antibodies was transferred into a glass B.D. syringe containing 200 μL of the PVP and distilled water solution. After the transfer, the syringe was sealed with parafilm and vortex-mixed for 5 minutes. Immediately following the vortex mixing, the solution was electrospun using a voltage of 10 kV, a working distance of 10 cm, and a flow rate of 1 ml/hr.

The as-spun samples were subsequently analyzed under an Olympus FV1000 Confocal Microscope, to measure fluorescence and to determine the dispersion of antibodies in the as-spun mat. A small piece of the mat was removed and placed on a glass slide for viewing. Slides were washed with distilled water before being examined. In the images obtained a clear distribution of fluorescence can be seen across the mat, thus confirming that the antibodies were embedded into the PVP nanofibers. The post-wash would not show any fluorescence if the antibodies were just sprayed onto the mat as the antibodies would be removed during the washing step.

Porphyrins can be used as labeling dyes for the antibodies to manifest the binding of the latter to the specific antigens targeted in this work. Porphyrins typically bind covalently to a protein molecule (M. Danquah, Journal of Natural Products 80, 1232 (2017)). Conjugation of porphyrin to monoclonal antibodies was described by Hudson et al. (R. Hudson, M. Carcenac et al., British Journal of Cancer 92, 1442 (2005)). That work targeted tumor-associated antigens. Varying concentrations of porphyrin in DMSO or water were added to the solution of monoclonal antibodies at various concentrations. Mixtures were then gently agitated at room temperature for 1 hour, void of light. The porphyrin was then conjugated to the monoclonal antibodies. A similar procedure can be employed herein. The advantage of the process is that different color output for different targeted analytes can be chosen and even an electrochemical/electronic output that can be transmitted wirelessly using Bluetooth technology (A. Bishop, C. Balazsi et al., Polymers for Advanced Technologies 17, 902 (2006)).

The sensors and methods described herein can be used by people who are concerned about the formaldehyde, allergen, or other chemical exposure in their home. People might be concerned because of recent health symptoms, other respiratory disorders, or because of recent purchases that might release chemicals. The person would purchase this system and could then easily measure the formaldehyde in their home. They could make changes if needed, and then test again. This disclosure also contemplates that the sensors and methods described herein can be used by professionals such as environmental service providers.

The sensors and methods described herein have applications in healthcare settings where clinicians are working with patients who might have symptoms related to exposure of indoor chemicals or allergens. This might include children or adults with asthma or allergies.

The sensors and methods described herein can be used in the building industry by builders who use low-emission materials and want to demonstrate to consumers that their buildings are healthier.

The sensors and methods described herein have potential applications in the wood industry to demonstrate that products comply with standards related to chemical emissions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A sensor for the detection of formaldehyde, comprising:
(i) a substrate; and
(ii) a reporter compound having the structure: 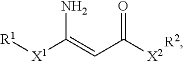
wherein
X¹ and X² are independently selected from null, O, S, and NR³;
R¹ and R² are independently selected from C₁₋₈alkyl, aryl, C₁₋₈heteroaryl, C₁₋₈heterocyclyl, or linker conjugated to the substrate;
R³ is in each case independently selected from H, C₁₋₈alkyl, aryl, C₁₋₈heteroaryl, C₁₋₈heterocyclyl,
wherein any of said alkyl, aryl, heteroaryl, and heterocyclyl groups may be conjugated to the substrate through a linker, and/or substituted one or more times by halide, OR, NH(CO)R, SR, PR₂, C(O)R, C(O)OR, C(O)NHR, NR₃, OH, NH₂, SO₃X³, NO₂, PO₃X³, wherein R is C₁₋₈alkyl, aryl, C₁₋₈heteroaryl, C₁₋₈heterocyclyl, X³ is H or acceptable cation, present in the stoichiometric amount needed for electroneutrality.

2. The sensor of claim 1, wherein X¹ and X² are each null.

3. The sensor of claim 1, wherein R¹ and R² are the same.

4. The sensor of claim 1, wherein R¹ and R² are each C₁₋₄alkyl.

5. The sensor of claim 1, wherein R¹ and R² are each phenyl or napthyl.

6. The sensor of claim 1, wherein R¹ and R² are each napth-1-yl or napth-2-yl.

7. The sensor of claim 1, wherein R¹ and R² are each independently phenyl having one or more R substituents in the 2, 4, or 6 positions, napth-1-yl having one or more R substituents in the 2, 4, 5, or 7 positions, or napth-2-yl having one or more R substituents in the 1, 3, 6 or 8 position.

8. The sensor of claim 1, wherein the reporter compound is impregnated, coated, and/or conjugated to the substrate.

9. The sensor of claim 1, wherein the substrate comprises a cellulosic material.

10. The sensor of claim 1, wherein the reporter compound is present in an amount less than 5% by weight, less than 2.5% by weight, less than 1% by weight, less than 0.5% by weight, or less than 0.1% by weight, relative to the weight of the substrate.

11. The sensor of claim 1, prepared by a process comprising the steps:
(i) forming a solution or dispersion of the reporter compound in a suitable solvent;
(ii) contacting the substrate with the solution or dispersion; and
(iii) evaporating the solvent.

12. The sensor of claim 1, prepared by a process comprising submerging the substrate in a solution or dispersion of the reporter compound, or spraying, painting, or coating a solution or dispersion of the reporter compound on at least one surface of the substrate.

13. The sensor of claim 1, wherein the sensor comprises a reporter compound conjugated to a cellulosic material.

14. The sensor of claim 1, comprising a conjugate having the formula: 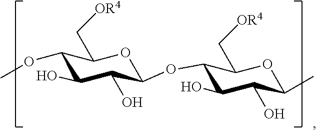
wherein R⁴ is in each case independently selected from H and a group having the formula:

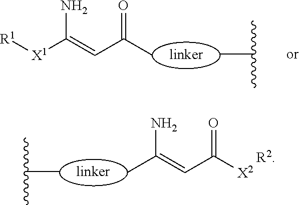

15. The sensor of claim 1, comprising a conjugate having the formula: 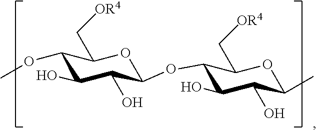
wherein R⁴ is in each case independently selected from H and a group having the formula: 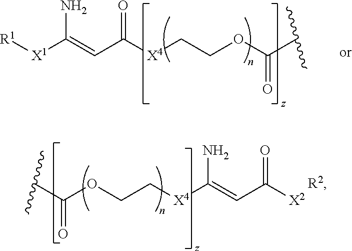
wherein X⁴ is independently selected from null, O, S, and NR³, n is independently selected from 1-10, and z is independently selected from 0 or 1.

16. The sensor of claim 1, wherein R⁴ is H in at least 5% of occurrences, at least 10% of occurrences, at least 25% of occurrences, at least 50% of occurrences, at least 75% of occurrences, or at least 90% of occurrences.

17. The sensor of claim 1, wherein the substrate is in contact with a base.

18. The sensor of claim 1, wherein the substrate is in contact with a transparent base.

19. The sensor of claim 1, wherein the substrate is in contact with an opaque base.

20. A sensor for detecting an allergen comprising a composite material including a nanofibrous substrate and an antibody with specificity for the allergen encapsulated within the nanofibrous substrate.

21. The sensor of claim 20, wherein the allergen comprises an airborne allergen or an environmental allergen.

22. The sensor of claim 20, wherein the allergen is selected from Bla g 1, Bla g 2, Can f 1, Can f 3, Der f 1, Der f 2, Der p 1, Der p2, Feld 1, Feld 2, Mus m 1, and Rat n 1.

23. The sensor of claim 20, wherein the antibody is selected from 10A4 anti Rat n 1, 10D4 anti Can f 1, 10H4 anti Rat n 1, 1A8 anti Fel d 4, 2H6 ant Rat n 1, 3E4 anti Fel d 1, 5B2 anti Fel d 4, 6E9 anti Can f 1, 6F9 anti Fel d 1, 7E6 anti Can f 1, 10A6 anti Bla g 1, 1F3 anti Bla g 2, 1G9 anti Bla g 5, 2F1 anti Bla g 2, 4B8 anti Bla g 5, 7C11 anti Bla g 2, 10B9 anti Der p 1, 4C1 anti Der p 1/Der f 1, 4D9 anti Blo t 5, 4G9 anti Blo t 5, 5H8 anti Der p 1, 6A8 anti Der f 1, 2C10 anti Alt a 1, and 4A6 anti Asp f 1.

24. The sensor of claim 20, wherein the nanofibrous material is prepared by electrospinning a mixture of a polymer and the antibody.

25. The sensor of claim 20, wherein the nanofibrous material comprises polyvinylpyrrolidone (PVP), polyvinylalcohol (PVA), polyethylene glycol (PEG), or polypropylene glycol (PPG).

26. The sensor of claim 20, wherein the antibody is conjugated to a labeling agent.

27. The sensor of claim 20, wherein the labeling agent comprises a dye.

28. The sensor of claim 27, wherein the labeling agent comprises a porphyrin.

29-60. (canceled)
